(19) United States
(12) Patent Application Publication
(10) Pub. No.: US 2014/0004460 A1
(43) Pub. Date: Jan. 2, 2014

(54) TONER

(71) Applicants: Daisuke Yoshiba, Suntou-gun (JP); Yoshihiro Ogawa, Toride-shi (JP); Kouji Nishikawa, Susono-shi (JP); Shigeto Tamura, Suntou-gun (JP); Naohiko Tsuchida, Abiko-shi (JP); Masami Fujimoto, Suntou-gun (JP)

(72) Inventors: Daisuke Yoshiba, Suntou-gun (JP); Yoshihiro Ogawa, Toride-shi (JP); Kouji Nishikawa, Susono-shi (JP); Shigeto Tamura, Suntou-gun (JP); Naohiko Tsuchida, Abiko-shi (JP); Masami Fujimoto, Suntou-gun (JP)

(73) Assignee: CANON KABUSHIKI KAISHA, Tokyo (JP)

(21) Appl. No.: 14/005,250

(22) PCT Filed: Mar. 21, 2012
(86) PCT No.: PCT/JP2012/058038

§ 371 Date: Sep. 13, 2013

(30) Foreign Application Priority Data
Mar. 29, 2011 (JP) 2011-072823

(51) Int. Cl. G03G 9/097

(52) U.S. Cl. CPC G03G 9/09783
USPC 430/108.23

(57) ABSTRACT

A toner is provided in which low-temperature fixing properties and high-temperature offset resistance can be compatible, and the environmental stability of image density can also be obtained.

A toner obtained by condensation polymerization of an alcohol component containing not less than 70 mol % of an aliphatic polyalcohol with a carboxylic acid component, and including a polyester resin having a concentration of an ester group of not less than 25% by mass and not more than 55% by mass, and

a compound represented by the following formula (1) as a charge-controlling agent:

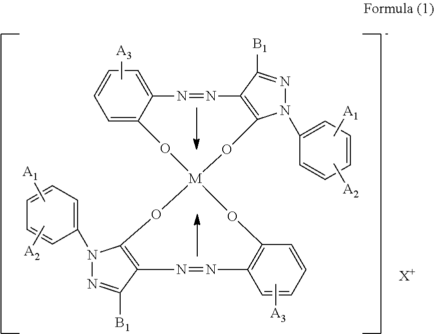

(wherein A₁, A₂, and A₃ each independently represent H, a nitro group, or a halogen atom; B₁ represents H or an alkyl group; M represents an Fe atom, a Cr atom, or an Al atom; X⁺ represents a H ion, an alkali metal ion, a NH₄ ion, an alkylammonium ion, or mixed ions thereof.)

### TECHNICAL FIELD

The present invention relates to a toner having negative triboelectric charging properties used for an image forming method such as electrophotography.

### BACKGROUND ART

In electrophotographic apparatuses, it has been demanded that high quality images are stably provided not only under a normal temperature and normal humidity environment but also under a high temperature and high humidity environment and under a low temperature and low humidity environment. Particularly, in order to achieve energy saving, further improvement in the low-temperature fixing properties of the toner has been demanded. In order to enhance the low-temperature fixing properties, PTL 1 proposes a method in which the concentration of ester groups and the concentration of aromatic rings in a polyester resin are specified.

Moreover, in an office, the environment under which the electrophotographic apparatus is used is controlled to a normal humidity environment during the office hours by an air conditioner. At night, however, the air conditioner is turned off from the viewpoint of energy saving, and therefore the electrophotographic apparatus is exposed to a high humidity environment, although temporarily. As a result, the humidity often changes. The toner repeatedly adsorbs and desorbs moisture, and is influenced by humidity history. In order to stably provide a high quality image even under such an environment, a toner that is not influenced by humidity history and can demonstrate a stable performance has been demanded. In order to stably provide a high quality image even in a case where the environment greatly changes, the triboelectric charging properties of the toner need to be controlled. For this, a charge-controlling agent is used for the toner in the prior art. PTL 2 and PTL 3 disclose a pyrazolone monoazo iron complex as a charge-controlling agent having negative triboelectric charging properties. According to the description of PTL 2 and PTL 3, if such a charge-controlling agent is used for the toner, then the toner has a large amount of triboelectric charge, the rise of triboelectric charging is fast, and environmental stability is excellent.

Unfortunately, the polyester resin according to PTL 1 has a high concentration of ester groups, which are hydrophilic groups, and the polyester resin in the toner particles easily absorbs moisture under a high humidity environment. The toner having toner particles using such a polyester resin is easily influenced by humidity history, and the triboelectric charging properties of the toner may be reduced by fluctuation in humidity, leading to reduction in image density or increase in fogging.

Moreover, PTL 2 and PTL 3 do not mention improvement in the triboelectric charging properties of the polyester resin.

### CITATION LIST

### Patent Literature

PTL 1: Japanese Patent Application Laid-Open No. 2009-251248
PTL 2: Japanese Patent No. 3986488
PTL 3: International Application No. WO2005/095523

### SUMMARY OF INVENTION

### Technical Problem

As described above, a toner having excellent low-temperature fixing properties and good triboelectric charging properties in various environments has been desired. An object of the present invention is to provide a toner having excellent low-temperature fixing properties and good triboelectric charging properties in various environments.

### Solution to Problem

The present invention is a toner having toner particles, each of which includes a binder resin and a charge-controlling agent, wherein the binder resin is a polyester resin obtained by condensation polymerization of an alcohol component containing not less than 70 mol % of an aliphatic polyalcohol with a carboxylic acid component; the polyester resin has a concentration of ester groups of not less than 25% by mass and not more than 55% by mass; and the charge-controlling agent is a compound represented by the following formula (1):

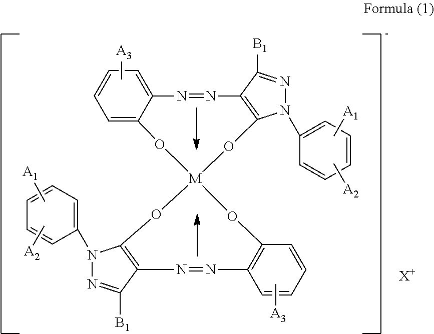

(wherein A₁, A₂, and A₃ each independently represent a hydrogen atom, a nitro group, or a halogen atom; B₁ represents a hydrogen atom or an alkyl group; M represents an Fe atom, a Cr atom, or an Al atom; X⁺ represents a hydrogen ion, an alkali metal ion, an ammonium ion, an alkylammonium ion, or mixed ions thereof.)

### Advantageous Effects of Invention

According to the present invention, a toner having excellent low-temperature fixing properties and good triboelectric charging properties even under a high temperature and high humidity environment can be provided.

### DESCRIPTION OF EMBODIMENTS

As a result of research, the present inventors found out that if a specific polyester resin obtained from an aliphatic polyalcohol is used as a binder resin, and a specific monoazo metal compound is used as toner particles, then a toner having excellent low-temperature fixing properties and negative-polarity triboelectric charging properties is obtained.

Namely, in the toner according to the present invention, a polyester resin obtained by condensation polymerization of an alcohol component containing not less than 70 mol % of an aliphatic polyalcohol with a carboxylic acid component and having a concentration of ester groups of not less than 25% by mass and not more than 55% by mass (hereinafter, also referred to as an aliphatic alcohol polyester resin) is used as the binder resin, and a compound represented by the following formula (1) is used as the charge-controlling agent.

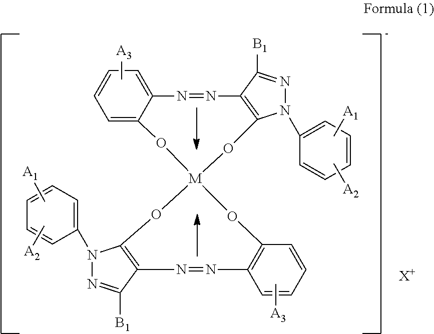

(wherein A₁, A₂, and A₃ each independently represent a hydrogen atom, a nitro group, or a halogen atom; B₁ represents a hydrogen atom or an alkyl group; M represents an Fe atom, a Cr atom, or an Al atom; X⁺ represents a hydrogen ion, an alkali metal ion, an ammonium ion, an alkylammonium ion, or mixed ions thereof.)

As described below, because of the configuration above the toner according to the present invention can achieve the compatibility between low-temperature fixing properties and triboelectric charging properties of the toner at a higher level than the conventional toner.

Examples of a resin used as the binder resin for the toner include polyester resins and styrene-acrylic resins. Among these, as the polyester resin, a polyester resin in which an alcohol monomer for forming a polyester resin has a bisphenol A unit and an alkylene oxide unit (hereinafter, also referred to as a bisphenol polyester resin) is usually used. As the charge-controlling agent, for example, an iron azo complex made by Hodogaya Chemical Co., Ltd. (T-77) is usually used. Here, the difference in effect between the toner according to the present invention and other toners will be described.

(a) A toner in which a styrene-acrylic resin is used as the binder resin, and the iron azo complex (T-77) is used as the charge-controlling agent

(b) A toner in which a styrene-acrylic resin is used as the binder resin, and a compound represented by the formula (1) is used as the charge-controlling agent

(c) A toner in which a bisphenol polyester resin is used as the binder resin, and the iron azo complex (T-77) is used as the charge-controlling agent

(d) A toner in which a bisphenol polyester resin is used as the binder resin, and a compound represented by the formula (1) is used as the charge-controlling agent

(e) A toner in which an aliphatic alcohol polyester resin is used as the binder resin, and the iron azo complex (T-77) is used as the charge-controlling agent

The toner having configuration (a) uses a styrene-acrylic resin as the binder resin. Usually, the styrene-acrylic resin has moisture absorption resistance, and thus high triboelectric charging properties are obtained even under a high temperature and high humidity environment. On the other hand, the molecular weight and gel of the styrene-acrylic resin can be controlled in a smaller range, and thus the low-temperature fixing properties of the styrene-acrylic resin are likely to decrease more than those of the polyester resin. Accordingly, the toner according to the present invention has better low-temperature fixing properties and triboelectric charging properties than those of the toner having configuration (a). The same is true for the toner having configuration (b) in which a compound represented by the formula (1) is used as the charge-controlling agent.

The toner having configuration (c) uses a bisphenol polyester resin as the binder resin. Usually, the polyester resin has better low-temperature fixing properties of the toner than those of the styrene-acrylic resin. However, in the bisphenol polyester resin, steric hindrance of the structure derived from bisphenol A easily reduces the freedom of molecular chains that constitute the molten resin in the toner. Accordingly, in the toner having configuration (c), it is difficult to obtain as good low-temperature fixing properties as those of the toner using an aliphatic alcohol polyester resin. The same is true for the toner having configuration (d) using a compound represented by the formula (1) as the charge-controlling agent.

The toner having configuration (e) uses an aliphatic polyalcohol polyester resin as the binder resin, and has excellent low-temperature fixing properties. In the aliphatic polyalcohol polyester resin, however, the concentration of ester groups, which are hydrophilic, is high, and thus the polyester resin is likely to absorb moisture to reduce the triboelectric charging properties particularly under a high temperature and high humidity environment in which a humidity at the temperature of 30° C. is more than 80% RH. On the other hand, the iron azo complex (T-77) as the charge-controlling agent also has moisture absorption properties, and thus it is difficult to maintain sufficient triboelectric charging properties in a high humidity environment. Accordingly, in a case where such a binder resin and the iron azo complex (T-77) are used, reduction in the triboelectric charging properties due to moisture absorption cannot be suppressed. Particularly, the triboelectric charging properties of the toner cannot be sufficiently obtained under a high temperature and high humidity environment, and the image density is likely to decrease or fogging is likely to increase.

On the other hand, the toner according to the present invention uses an aliphatic alcohol polyester resin as the binder resin and a compound represented by the formula (1) as the charge-controlling agent. The compound represented by the formula (1) has moisture absorption resistance. For this, if a compound represented by the formula (1) is used as the charge-controlling agent, the triboelectric charging properties of the charge-controlling agent can be maintained even if the toner is exposed to the high humidity environment, leading to improvement in image density and fogging. Further, because of high low-temperature fixing properties of the aliphatic alcohol polyester resin, the toner according to the present invention can achieve the compatibility between the low-temperature fixing properties and the triboelectric charging properties at a high level.

Thus, the toner according to the present invention uses an aliphatic alcohol polyester resin and the compound represented by the formula (1) to demonstrate a remarkable effect. Moreover, in the toners according to other combinations of the binder resin and the charge-controlling agent, it is difficult to achieve the compatibility between the low-temperature fixing properties and the triboelectric charging properties at a high level as in the present invention.

Hereinafter, the present invention will be described in detail.

The polyester resin used for the present invention is obtained by condensation polymerization of an alcohol component containing not less than 70 mol % of an aliphatic polyalcohol with a carboxylic acid component. In a case where the polyester resin is prepared using only an aliphatic polyalcohol as the alcohol component, the polyester resin does not have the structure derived from bisphenol A. Accordingly, steric hindrance in the molecule is reduced, and the molecules are likely to move actively by heat, leading to improvement in the low-temperature fixing properties. Moreover, orientation between the molecules is likely to be increased, leading to improvement in sharp melting properties of the toner. Preferably, the polyester resin used for the present invention is obtained by condensation polymerization of an alcohol component containing not less than 80 mol % and not more than 100 mol % of an aliphatic polyalcohol with a carboxylic acid component.

In the polyester resin used for the present invention, the concentration of ester groups is not less than 25% by mass and not more than 55% by mass. The concentration of the ester group represents % by mass of the ester group per unit mass of the resin. In a case where the polyester resin is prepared using an aliphatic polyalcohol as the alcohol component, the concentration of the ester group is increased. Conversely, in the polyester resin prepared using bisphenol A alkylene oxide as the alcohol component, the concentration of the ester group is less than 25% by mass. This is because the number of the ester group per unit mass of the resin is reduced by the structure derived from a bisphenol A unit having a large molecular weight. If the polyester resin having a concentration of the ester group in the range above is used for the toner, the low-temperature fixing properties of the toner can be compatible with high-temperature offset resistance. The concentration of the ester group of the polyester resin used for the present invention is preferably not less than 30% by mass and not more than 50% by mass.

The concentration of the ester group (% by mass) in the polyester resin according to the present invention can be determined as follows. The polyester resin is subjected to a composition analysis by NMR to determine the composition ratio derived from the respective monomers in the polyester resin. From the obtained monomer composition, the concentration of the ester group is determined using the following expression. The number of equivalents of the carboxyl group in the carboxylic acid component is compared with the number of equivalents of the hydroxyl group in the alcohol component, and a component (x) having the smaller number of equivalents is focused on. The mass of the monomer, the molecular weight of the monomer, and the number of the functional group in the component (x), and the mass of the produced resin are substituted into the following expression. In a case where the component (x) contains two or more monomers (n≧2), the total sum of the values calculated for the respective monomers is the concentration of the ester group. The concentration of the ester group in the present invention means the mass proportion of an ester bond “—COO—” (molecular weight of 44) in the polyester resin.

$$Concentration of ester group ( \% by mass ) = {\sum }_{i = 1}^{n} [ \frac{\frac{Pi}{Ri} \times Si \times 44}{Q} \times 100 ]$$

P: the mass of the monomer (calculated from the mass of the obtained polyester resin and the mol ratio obtained from the analysis)

Q: the mass of the produced resin

R: the molecular weight of the monomer

S: the number of the functional group of the monomer (the functional group is the hydroxyl group if the component (x) is alcohol, and the number of the carboxyl group if the component (x) is carboxylic acid)

n: kinds (the number) of the monomer in the component (x)

Preferably, the toner according to the present invention is obtained by condensation polymerization of the alcohol component containing not less than 70 mol % of an aliphatic polyalcohol with the carboxylic acid component, and contains not less than 50% by mass and not more than 100% by mass of the polyester resin based on the total amount of the resin in the toner, the polyester resin having the concentration of the ester group of not less than 25% by mass and not more than 55% by mass. More preferably, the concentration of the ester group is not less than 70% by mass and not more than 100% by mass based on the total amount of the resin in the toner.

The present inventors made extensive research about the charge-controlling agent that enhances the triboelectric charging properties of the toner. As a result, it was found out that if the monoazo metal complex having the structure represented by the formula (1) is used as the charge-controlling agent, the moisture absorption properties can be more significantly suppressed than in the conventional charge-controlling agent.

Although the reason why use of the charge-controlling agent can suppress the moisture absorption properties is not clear in detail, it is thought that the charge-controlling agent has a pyrazolone skeleton within a ligand and this may contribute to suppression of the moisture absorption properties. As described above, by use of the charge-controlling agent, the triboelectric charging properties of the toner can be kept even if the moisture-absorbing aliphatic alcohol polyester resin is used as the binder resin. As a result, the low-temperature fixing properties of the toner can be compatible with the triboelectric charging properties at a high level.

Further, the present inventors found out that in a case where the toner is prepared using a pulverizing method, the charge-controlling agent is used with the polyester resin in which the concentration of the ester group is controlled at not less than 25% by mass and not more than 55% by mass; thereby, dispersibility of the charge-controlling agent is improved, and a stable image density is obtained even in a long-term use. Although the reason for improvement in the dispersibility of the charge-controlling agent is not clear, it is thought that by controlling the concentration of the ester group within the range specified by the present invention, the difference in polarity between the polyester resin and the charge-controlling agent is reduced, and the charge-controlling agent is micro dispersed in the toner particles almost uniformly.

The counter ion X⁺ in the compound represented by the formula (1) represents a hydrogen ion, an alkali metal ion, an ammonium ion, an alkylammonium ion, or mixed ions thereof, and preferable is a hydrogen ion.

The charge-controlling agent used for the present invention is preferably a monoazo iron complex compound represented by the following formula (2):

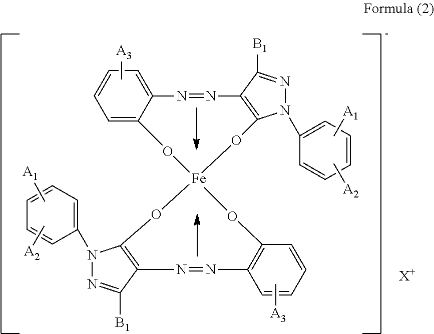

(wherein A₁, A₂, and A₃ each independently represent a hydrogen atom, a nitro group, or a halogen atom; B₂ represents a hydrogen atom or an alkyl group; X⁺ represents a hydrogen ion, an alkali metal ion, an ammonium ion, an alkylammonium ion, or mixed ions thereof.)

Namely, a coordinating metal is preferably iron. If the coordinating metal is iron, the stable triboelectric charging properties can be given to the toner for a long period of time.

More preferably, the charge-controlling agent used for the present invention is a monoazo iron complex compound represented by the following formula (3):

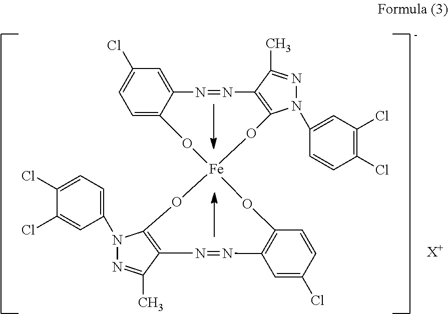

(wherein X⁺ represents a hydrogen ion, an alkali metal ion, an ammonium ion, an alkylammonium ion, or mixed ions thereof.)

If the charge-controlling agent has the structure represented by the formula (3), the charge-controlling agent is hardly influenced by humidity history.

In the charge-controlling agent used for the present invention, the amount of moisture to be adsorbed at a temperature of 30° C. and a humidity of 90% RH is preferably not more than 30 mg/g. More preferably, the amount is not more than 20 mg/g. Assuming a severer humidity environment, the amount of moisture to be adsorbed at a temperature of 30° C. and a humidity of 90% RH per charge-controlling agent unit weight is used as an index of the amount of moisture to be adsorbed of the charge-controlling agent.

As an index indicating the influence by humidity history, in adsorption and desorption isotherms of moisture at a temperature of 30° C. from a humidity of 5% RH to a humidity of 95% RH, the difference Δ(M2−M1) between the amount of moisture to be adsorbed M1 (mg/g) during the adsorption at a humidity of 65% RH and the amount of moisture to be adsorbed M2 (mg/g) at a humidity of 65% RH during the desorption having humidity history at a humidity of 95% RH is used. In the charge-controlling agent used for the present invention, Δ(M2−M1) is preferably not more than 4.0, and more preferably not more than 1.0. At Δ(M2−M1) within the range above, even if the charge-controlling agent adsorbs moisture once, the moisture is easily desorbed. Thereby, even if the toner is exposed to an ultra high humidity environment at a humidity of 95% RH, the moisture adsorbed by the charge-controlling agent is desorbed when the humidity reduces later. As a result, the toner is hardly influenced by humidity history.

Examples of the method for containing the compound as the charge-controlling agent used in the present invention in toner particles include: methods for adding (internally adding) the compound to the inside of the toner particles in advance such as a method of adding the charge-controlling agent and a colorant to the binder resin, mixing, and milling the mixture, or a method of adding the charge-controlling agent to a polymerizable monomeric monomer and polymerizing the mixture to obtain toner particles; and methods of producing toner particles in advance, and adding (externally adding) the charge-controlling agent to the surfaces of the toner particles.

The aliphatic polyalcohol used for the present invention preferably has not less than 2 and not more than 10 carbon atoms. At carbon atoms of the aliphatic polyalcohol within the range above, the low-temperature fixing properties of the toner is much better. The aliphatic polyalcohol preferably has not less than 2 and not more than 8 of carbon atoms.

Examples of the aliphatic polyalcohol having not less than 2 and not more than 10 carbon atoms include compounds as follows: ethylene glycol, 1,2-propanediol, 1,3-propanediol, 1,4-butanediol, 1,5-pentanediol, 1,6-hexanediol, neopentyl glycol, 1,4-butenediol, 1,7-heptanediol, 1,8-octanediol, 1,4-cyclohexanedimethanol, 1,9-nonanediol, 1,10-decanediol. Among these, one or more alcohol components selected from the group consisting of ethylene glycol, neopentyl glycol, 1,4-cyclohexanedimethanol, and 1,2-propanediol are preferably used. More preferable are ethylene glycol and neopentyl glycol.

The alcohol component may contain an aromatic polyalcohol component other than the aliphatic polyalcohol having not less than 2 and not more than 10 carbon atoms. Examples of such an aromatic polyalcohol component include alkylene (carbon atoms of 2 and 3) oxides (the average number of mols of addition of not less than 1 and not more than 10) adducts of bisphenol A. Specifically, examples thereof include polyoxypropylene(2.2)-2,2-bis(4-hydroxyphenyl)propane, and polyoxyethylene(2.2)-2,2-bis(4-hydroxyphenyl)propane. The content of the aromatic polyalcohol component needs to be less than 30 mol % based on the total amount of the alcohol component.

Examples of the carboxylic acid component used for the polyester resin include various polyvalent carboxylic acids and anhydrides thereof: benzenedicarboxylic acids or anhydrides thereof such as phthalic acid, terephthalic acid, isophthalic acid, and phthalic anhydride; alkyldicarboxylic acids such as succinic acid, adipic acid, sebacic acid, azelaic acid or anhydrides thereof; succinic acid substituted by an alkyl group or an alkenyl group having not less than 6 and not more than 18 carbon atoms or anhydrides thereof; and unsaturated dicarboxylic acids such as fumaric acid, maleic acid, citraconic acid, itaconic acid or anhydrides thereof. Among these, one or more carboxylic acid components selected from the group consisting of terephthalic acid, fumaric acid, trimellitic acid, and trimellitic anhydride is preferably used.

The polyester resin used for the present invention preferably has a crosslinking structure of a polyvalent carboxylic acid having a valence of 3 or more or an anhydride thereof and/or a polyhydric alcohol having a valence of 3 or more. Examples of polyvalent carboxylic acids having a valence of 3 or more or anhydrides thereof include: 1,2,4-benzenetricarboxylic acid, 1,2,4-cyclohexanetricarboxylic acid, 1,2,4-naphthalenetricarboxylic acid, pyromellitic acid, acid anhydrides thereof, and lower alkyl esters. Examples of polyhydric alcohols having a valence of 3 or more include: 1,2,3-propanetriol, trimethylolpropane, hexanetriol, and pentaerythritol. Among these, 1,2,4-benzenetricarboxylic acid (trimellitic acid) or anhydrides thereof are preferably used from the viewpoint of change by the environment.

One of the polyester resins may be used alone, or two of the resins having different viscosities may be mixed and used. For example, a high-viscosity polyester resin and a low-viscosity polyester resin may be mixed and used. The high-viscosity polyester resin preferably has a softening point of not less than 120° C. and not more than 150° C. The low-viscosity polyester resin preferably has a softening point of not less than 70° C. and less than 120° C.

In a case where one of the polyester resins is used alone, the softening point (Tm) is preferably not less than 90° C. and not more than 150° C. More preferably, the softening point (Tm) is not less than 95° C. and not more than 140° C. At a softening point (Tm) within the range above, the high-temperature offset resistance and the low-temperature fixing properties are balanced well.

The softening point is measured as follows. The softening point of the resin is measured using a Capillary Rheometer “Rheological Properties Evaluation Apparatus Flowtester CFT-500D” by a constant load extrusion method (made by SHIMADZU Corporation) according to the manual attached to the apparatus. In the apparatus, while a constant load is applied to a sample to be measured from above by a piston, the temperature of the sample filled into the cylinder is raised to melt the sample. The molten sample to be measured is extruded from a die in the bottom of a cylinder. A flow curve showing a relationship between the amount of the piston stroke and the temperature at this time can be obtained.

The “melting point in the ½ method” attached to the “Rheological Properties Evaluation Apparatus Flowtester CFT-500D” is defined as the softening point. The melting point in the ½ method is calculated as follows. First, ½ of the difference between the amount of the piston stroke Smax when the flow is completed and the amount of piston stroke 5 min when the flow is started is determined (the value is defined as X. X=(Smax−5 min)/2). Then, the temperature in the flow curve when the amount of the piston stroke is the sum of X and 5 min in the flow curve is the melting point Tm in the ½ method.

As the sample to be measured, used is the one obtained by pressure molding approximately 1.0 g of a sample into a cylindrical shape having a diameter of approximately 8 mm under an environment of 25° C. at approximately 10 MPa for approximately 60 seconds using a tablet molding press machine (for example, NT-100H, made by NPa SYSTEM CO., LTD.).

The measurement condition of the CFT-500D is as follows.

Test mode: temperature raising method

Starting temperature: 50° C.

Target temperature: 200° C.

Interval of measurement: 1.0° C.

Temperature raising rate: 4.0° C./min

Area of the cross section of the piston: 1.000 cm²

Test load (load applied by the piston): 10.0 kgf (0.9807 MPa)

Preheating time: 300 seconds

Diameter of the opening of the die: 1.0 mm

Length of the die: 1.0 mm

From the viewpoint of reservation stability and low-temperature fixing properties, the glass transition temperature (Tg) of the polyester resin is preferably 1 not less than 45° C. and not more than 75° C. Further, from the viewpoint of reservation stability, the glass transition temperature (Tg) is particularly preferably not less than 50° C. and not more than 65° C.

The glass transition temperature (Tg) of the polyester resin is measured under a normal temperature and normal humidity environment using a differential scanning calorimeter (DSC) MDSC-2920 (made by TA Instruments-Waters LLC) according to ASTM D3418-82. As the sample to be measured, approximately 3 mg of the polyester resin is precisely weighed and used. The sample is placed in an aluminum pan, and an empty aluminum pan is used as a reference. The range of the measurement temperature is not less than 30° C. and not more than 200° C. The temperature is raised at a temperature rising rate of 10° C./min from a temperature of 30° C. to a temperature of 200° C. once, and subsequently lowered at a temperature falling rate of 10° C./min from a temperature of 200° C. to a temperature of 30° C. Then, again, the temperature is raised at a temperature rising rate of 10° C./min to a temperature of 200° C. In the DSC curve obtained in the second temperature raising process, a point of intersection of a line from a midpoint of the baseline before and after the specific heat changes and the DSC curve is defined as a glass transition temperature Tg of the resin.

The condensation polymerization of the carboxylic acid component with the alcohol component in preparation of the polyester resin can be performed using a known esterification reaction. As an ordinary method, in an inert gas (nitrogen gas, or the like) atmosphere, the reaction temperature is not less than 150° C. and not more than 280° C. The reaction time is not less than 30 minutes and not more than 40 hours from the viewpoint of surely performing the polycondensation reaction. The reaction time is preferably not less than 2 hours. Moreover, the polyester resin can be produced under reduced pressure in order to improve the reaction rate at the final stage of the reaction. In order to promote the reaction, when necessary, a known esterification catalyst such as sulfuric acid, titanium butoxide, dibutyltin oxide, magnesium acetate, and manganese acetate can be used. Particularly, from the viewpoint of fixing properties, a titanium-containing catalyst is preferably used as the esterification catalyst.

Preferably, the polyester resin used for the present invention is obtained from an alcohol component or carboxylic acid component containing a component derived from biomass. Recently, as new efforts to prevent global warming, use of a plant-derived resource called the biomass has received great attention. Carbon dioxide produced during burning the biomass is originally carbon dioxide in the air taken in by the plants by photosynthesis. Accordingly, the balance of carbon dioxide in the air is zero from an overall viewpoint, and the total amount thereof is not changed. Thus, the property of giving no influence on increase and reduction in carbon dioxide in the air is called carbon neutral. By use of the carbon neutral plant-derived resource, the amount of carbon dioxide in the air can be fixed. The plastics produced from such biomass are called biomass polymers, biomass plastics, or non-petroleum polymer materials, and the monomer for these raw materials is called a biomass monomer.

In a case where the polyester resin used for the present invention is prepared, a biomass monomer such as 1,2-propanediol is preferably used as the alcohol component.

Because the physical properties of 1,2-propanediol are easy to control, 1,2-propanediol is preferably used as the alcohol component. Unfortunately, because the molecular weight is low, the concentration of the ester group is likely to be increased, and environmental stability is poor. Accordingly, 1,2-propanediol is preferably used in combination with the compound (charge-controlling agent) used for the present invention.

The compound represented by the formula (1) used as the charge-controlling agent in the present invention can be produced using a known method for producing a monoazo complex compound. Hereinafter, a typical production method will be described.

A mineral acid such as hydrochloric acid and sulfuric acid is added to a diazo component such as 4-chloro-2-aminophenol, and when the temperature of the solution reaches the temperature of not more than 5° C., sodium nitrite dissolved in water is dropped while the temperature of the solution is kept at not more than 10° C. The solution is stirred at a temperature of not more than 10° C. for not less than 30 minutes and not more than 3 hours to make a reaction. Thus, 4-chloro-2-aminophenol is formed into a diazo compound. Sulfamic acid is added, and using a potassium iodide starch paper, it is checked that nitrous acid does not excessively remain.

Next, 3-methyl-1-(3,4-dichlorophenyl)-5-pyrazolone as a coupling component, an aqueous solution of sodium hydroxide, sodium carbonate, and an organic solvent are added, and stirred at room temperature and dissolved. The diazo compound is added to the solution, and stirred at room temperature for several hours to perform coupling. After stirring, it is checked that the diazo compound does not react with resorcin, and the reaction is terminated. Water is added, and sufficiently stirred. Then, the solution is left as it is, and separated. Further, a sodium hydroxide aqueous solution is added, and stirring and washing are performed. Then, the solution is separated. Thereby, a solution of a monoazo compound is obtained.

As the organic solvent used for the coupling, univalent alcohols, divalent alcohols, and ketone organic solvents are preferred. Examples of univalent alcohols include methanol, ethanol, n-propanol, 2-propanol, n-butanol, isobutyl alcohol, sec-butyl alcohol, n-amylalcohol, isoamyl alcohol, and ethylene glycol monoalkyl (carbon atoms of 1 to 4) ethers. Examples of divalent alcohols include ethylene glycol, and propylene glycol. Examples of the ketone organic solvents include methyl ethyl ketone, and methyl isobutyl ketone.

Next, a metallization reaction is performed. Water, salicylic acid, n-butanol, and sodium carbonate are added to the solution of the monoazo compound, and stirred. In a case where iron is used as the coordinating metal, a ferric chloride aqueous solution and sodium carbonate are added. The temperature of the solution is raised to a temperature of 30° C. to 40° C., and the reaction is monitored by TLC. After 5 hours to 10 hours have passed, it is checked that spots of the raw material disappear, and the reaction is terminated. After stirring is stopped, the solution is left as it is, and separated. Further, water, n-butanol, and a sodium hydroxide aqueous solution are added to perform alkali washing. The solution is filtered to extract a cake, and the cake is washed with water.

In a case where any counter ion is used, for example, sodium hydroxide is added to water; the solution is stirred while the temperature is raised; when the temperature of water reaches a temperature of 85° C. to 90° C., the dispersion solution of the cake is dropped. The solution is stirred at a temperature of 97° C. to 99° C. for 1 hour, cooled, and filtered. Then, the cake is washed with water. The cake is dried in vacuum, and it is checked that the amount of the cake reaches a constant weight. Thus, monoazo metal complex compound used for the present invention can be obtained.

In a case where the monoazo metal complex compound is internally added to the toner particles, the amount of the compound to be added is preferably not less than 0.1 parts by mass and not more than 10 parts by mass, and more preferably not less than 0.2 parts by mass and not more than 5 parts by mass based on 100 parts by mass of the resin for the toner. In a case where the monoazo metal complex compound is externally added to the toner particles, the amount of the compound to be added is preferably not less than 0.01 parts by mass and not more than 5 parts by mass, and more preferably not less than 0.01 parts by mass and not more than 2 parts by mass.

In the toner according to the present invention, as the binder resin, the polyester resin may be used alone, or may be used in combination with other resin.

Examples of resins other than the polyester resin include vinyl resins, styrene resins, styrene copolymerized resins, polyol resins, polyvinyl chloride resins, phenol resins, naturally modified phenol resins, natural resin-modified maleic acid resins, acrylic resins, methacrylic resins, polyvinyl acetate, silicone resins, polyurethane resins, polyamide resins, fran resins, epoxy resins, xylene resins, polyvinyl butyral, terpene resins, coumarone indene resins, and petroleum resins. Examples of resins preferably used include styrene copolymerized resins and hybrid resins obtained by bonding a polyester unit to a vinyl polymer unit.

Examples of vinyl monomers for forming vinyl resins or vinyl polymer units for the hybrid resin include the following compounds: styrenes such as styrene, o-methylstyrene, m-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, and p-n-dodecylstyrene and derivatives thereof; α,β-unsaturated acids such as acrylic acid, methacrylic acid, crotonic acid, and cinnamic acid; α-methylene aliphatic monocarboxylic acid esters such as methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, and diethylaminoethyl methacrylate; acrylic acid esters such as methyl acrylate, ethyl acrylate, n-butyl acrylate, isobutyl acrylate, propyl acrylate, n-octyl acrylate, dodecyl acrylate, 2-ethylhexyl acrylate, stearyl acrylate, 2-chloroethyl acrylate, and phenyl acrylate; acrylic acids such as acrylonitrile, (meth)acrylonitrile, and acrylamide or methacrylic acid derivatives. The vinyl resins or the vinyl polymer units may have a crosslinking structure crosslinked by a crosslinking agent having two or more vinyl groups. Examples of preferably used crosslinking agents include divinylbenzene.

The amount of these crosslinking agents that can be used is not less than 0.01 parts by mass and not more than 10.00 parts by mass, and more preferably not less than 0.03 parts by mass and not more than 5.00 parts by mass based on 100 parts by mass of other monomer component.

Among these crosslinking agents, examples of those suitably used for the resin for the toner for the fixing properties and the offset resistance include aromatic divinyl compounds (particularly, divinylbenzene), and diacrylate compounds bonded by an aromatic group and a chain containing an ether bond.

Examples of polymerization initiators used for the polymerization of the vinyl resins or the vinyl polymer units include: 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobisisobutyrate, 1,1′-azobis(1-cyclohexanecarbonitrile), 2-(carbamoylazo)-isobutyronitrile, 2,2′-azobis(2,4,4-trimethylpentane), 2-phenylazo-2,4-dimethyl-4-methoxyvaleronitrile, 2,2-azobis(2-methylpropane), ketone peroxides such as methyl ethyl ketone peroxide, acetylacetone peroxide, cyclohexanone peroxide, 2,2-bis(tert-butylperoxy)butane, tert-butyl hydroperoxide, cumene hydroperoxide, 1,1,3,3-tetramethylbutyl hydroperoxide, di-tert-butyl peroxide, tert-butyl cumyl peroxide, dicumyl peroxide, α,α′-bis(tert-butylperoxyisopropyl)benzene, isobutyl peroxide, octanoyl peroxide, decanoyl peroxide, lauroyl peroxide, 3,5,5-trimethylhexanoyl peroxide, benzoyl peroxide, m-toluoyl peroxide, di-isopropylperoxydicarbonate, di-2-ethylhexylperoxydicarbonate, di-n-propylperoxydicarbonate, di-2-ethoxyethylperoxycarbonate, dimethoxyisopropylperoxydicarbonate, di(3-methyl-3-methoxybutyl)peroxycarbonate, acetylcyclohexylsulfonyl peroxide, tert-butyl peroxyacetate, tert-butyl peroxyisobutyrate, tert-butyl peroxyneodecanoate, tert-butyl peroxy-2-ethylhexanoate, tert-butyl peroxylaurate, tert-butyl peroxybenzoate, tert-butyl peroxyisopropylcarbonate, di-tert-butyl peroxyisophthalate, tert-butyl peroxyallylcarbonate, tert-amyl peroxy-2-ethylhexanoate, di-tert-butyl peroxyhexahydroterephthalate, and di-tert-butyl peroxyazelate.

In a case where the hybrid resin is used for the binder resin, the vinyl resin component and/or the polyester resin component preferably contains a monomer component reactive with both of the vinyl resin component and the polyester resin component resin component. Among the monomers that form the polyester resin component, examples of those reactive with the vinyl resin include unsaturated dicarboxylic acids such as phthalic acid, maleic acid, citraconic acid, and itaconic acid or anhydrides thereof. Among the monomers that form the vinyl resin component, examples of those reactive with the polyester resin component include monomers having a carboxyl group or a hydroxy group, acrylic acids, or methacrylic acid esters.

As the method for obtaining a reaction product of the vinyl resins and the polyester resin, preferred is a method in which in the presence of a polymer containing the monomer component reactive with the vinyl resin and the polyester resin, one or both of the resins is subjected to a polymerization reaction.

The toner according to the present invention can be used as a magnetic one component toner, a non-magnetic one component toner, and a non-magnetic toner for a two component developer.

In a case where the toner according to the present invention is used as the magnetic one component toner, magnetic iron oxide particles are preferably used as a colorant. Examples of magnetic iron oxide particles contained in the magnetic one component toner include magnetic iron oxides such as magnetite, maghemite, and ferrite; magnetic iron oxides containing other metal oxides; metals such as Fe, Co, and Ni, alloys of these metals and a metal such as Al, Co, Cu, Pb, Mg, Ni, Sn, Zn, Sb, Be, Bi, Cd, Ca, Mn, Se, Ti, W, and V, and a mixture thereof.

Examples of the colorant used in a case where the toner is used as the non-magnetic one component toner and the non-magnetic two component toner include:

As a black pigment, carbon black such as furnace black, channel black, acetylene black, thermal black, and lamp black is used. Moreover, magnetic powder such as magnetite and ferrite are also used.

As a suitable colorant for a yellow color, pigments or dyes can be used. Examples of the pigments include C.I. Pigment Yellows 1, 2, 3, 4, 5, 6, 7, 10, 11, 12, 13, 14, 15, 17, 23, 62, 65, 73, 74, 81, 83, 93, 94, 95, 97, 98, 109, 110, 111, 117, 120, 127, 128, 129, 137, 138, 139, 147, 151, 154, 155, 167, 168, 173, 174, 176, 180, 181, 183, and 191; and C.I. Vat Yellows 1, 3, and 20. Examples of the dyes include C.I. Solvent Yellows 19, 44, 77, 79, 81, 82, 93, 98, 103, 104, 112, and 162. One of these is used alone, or two or more thereof are used in combination.

As a suitable colorant for a cyan color, pigments or dyes can be used. Examples of the pigments include C.I. Pigment Blues 1, 7, 15, 15:1, 15:2, 15:3, 15:4, 16, 17, 60, 62, and 66; C.I. Vat Blue 6; and C.I. Acid Blue 45. Examples of the dyes include C.I. Solvent Blues 25, 36, 60, 70, 93, and 95. One of these is used alone, or two or more thereof are used in combination.

As a suitable colorant for a magenta color, pigments or dyes can be used. Examples of the pigments include C.I. Pigment Reds 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 48:2, 48:3, 48:4, 49, 50, 51, 52, 53, 54, 55, 57, 57:1, 58, 60, 63, 64, 68, 81, 81:1, 83, 87, 88, 89, 90, 112, 114, 122, 123, 144, 146, 150, 163, 166, 169, 177, 184, 185, 202, 206, 207, 209, 220, 221, 238, and 254; C.I. Pigment Violet 19; and C.I. Vat Reds 1, 2, 10, 13, 15, 23, 29, and 35. Examples of the dyes for magenta include oil-soluble dyes such as C.I. Solvent Reds 1, 3, 8, 23, 24, 25, 27, 30, 49, 52, 58, 63, 81, 82, 83, 84, 100, 109, 111, 121, and 122, C.I. Disperse Red 9, C.I. Solvent Violets 8, 13, 14, 21, and 27, and C.I. Disperse Violet 1; and basic dyes such as C.I. Basic Reds 1, 2, 9, 12, 13, 14, 15, 17, 18, 22, 23, 24, 27, 29, 32, 34, 35, 36, 37, 38, 39, and 40 and C.I. Basic Violets 1, 3, 7, 10, 14, 15, 21, 25, 26, 27, and 28. One of these is used alone, or two or more thereof are used in combination.

In order to give releasing properties to the toner, the toner particles preferably contain a mold release agent (wax). As the wax, low molecular weight polyethylenes, low molecular weight polypropylenes, and hydrocarbon waxes such as microcrystalline wax and paraffin wax are preferably used because these are easily dispersed in the toner and have high releasing properties. When necessary, one of waxes may be used, or a small amount of two or more thereof may be used in combination.

Examples of the waxes include:

oxides of aliphatic hydrocarbon waxes such as oxidized polyethylene wax, or block copolymers thereof; waxes containing fatty acid ester as a principal component such as carnauba wax, SASOL waxes, and montanic acid ester wax; and waxes having partially or totally deoxidized fatty acid ester such as deacidified carnauba wax. Further, examples of the waxes include:

saturated linear fatty acids such as palmitic acid, stearic acid, and montanic acid; unsaturated fatty acids such as brassidic acid, eleostearic acid, and parinaric acid; saturated alcohols; long-chainalkylalcohols such as stearyl alcohol, aralkyl alcohol, behenyl alcohol, carnaubyl alcohol, ceryl alcohol, and melissyl alcohol; polyhydric alcohols such as sorbitol; fatty acid amides such as linoleic acid amide, oleic acid amide, and lauric acid amide; saturated fatty acid bisamides such as methylenebisstearic acid amide, ethylenebiscapric acid amide, ethylenebislauric acid amide, and hexamethylenebisstearic acid amide; unsaturated fatty acid amides such as ethylenebisoleic acid amide, hexamethylenebisoleic acid amide, N,N-dioleyladipic acid amide, and N,N-dioleylsebacic acid amide; aromatic bisamides such as m-xylenebisstearic acid amide, and N,N-distearylisophthalic acid amide; fatty acid metallic salts such as calcium stearate, calcium laurate, zinc stearate, and magnesium stearate (usually, those referred to as metal soap); waxes obtained by grafting an aliphatic hydrocarbon wax with a vinyl monomer such as styrene and acrylic acid; partially esterified products of a fatty acid such as behenic acid monoglyceride and a polyhydric alcohol; and methylester compounds having a hydroxyl group and obtained by hydrogenating vegetable oils and fats.

Examples of waxes particularly preferably used in the present invention include aliphatic hydrocarbon waxes. Examples of aliphatic hydrocarbon waxes include: low molecular weight alkylene polymers obtained by radical polymerizing alkylene under high pressure or polymerizing alkylene under low atmospheric pressure using a Ziegler catalyst; alkylene polymers obtained by thermally decomposing a high molecular weight alkylene polymer; synthesized hydrocarbon waxes obtained from distillation residues of hydrocarbons obtained from a synthesis gas containing carbon monoxide and hydrogen by an Arge method and synthesized hydrocarbon waxes obtained by hydrogenating these; and waxes obtained by separating these aliphatic hydrocarbon waxes by a press perspiring method, a solvent method, use of vacuum distillation, and a fractional crystallization method.

Examples of hydrocarbons as a mother material for the aliphatic hydrocarbon waxes include: hydrocarbons synthesized by a reaction of carbon monoxide with hydrogen using a metal oxide catalyst (a multicomponent catalyst having two or more components in many cases) (for example, a hydrocarbon compound synthesized by a Syntol method and a Hydrocol method (using a fluid catalyst bed)); hydrocarbons having up to hundreds carbon atoms obtained by the Arge method (using a fixed catalyst bed) in which a large amount of wax-like hydrocarbon is obtained; and hydrocarbons obtained by polymerizing alkylene such as ethylene by the Ziegler catalyst. Among these hydrocarbons, preferable are saturated linear hydrocarbons in which the branching is little and small, and particularly preferable are hydrocarbons synthesized by a method not using polymerization of alkylene because of molecular weight distribution. Specifically, examples thereof include: VISCOLs (registered trademark) 330-P, 550-P, 660-P, TS-200 (Sanyo Chemical Industries, Ltd.); Hi Waxes 400P, 200P, 100P, 410P, 420P, 320P, 220P, 210P, and 110P (Mitsui Chemicals, Inc.); Sasol H1, H2, C80, C105, and C77 (Sasol Wax GmbH); HNP-1, HNP-3, HNP-9, HNP-10, HNP-11, and HNP-12 (NIPPON SEIRO CO., LTD.), UNILINs (registered trademark) 350, 425, 550, and 700, UNICIDs (registered trademark) 350, 425, 550, and 700 (Toyo-Petrolite Co., Ltd.); japan wax, beeswax, rice wax, candelilla wax, and carnauba wax (CERARICA NODA Co., Ltd.).

As the timing when the mold release agent is added, when the toner particles are prepared by the pulverizing method, the mold release agent may be added during melt kneading, or may be added during producing the binder resin. These mold release agents may be used alone, or may be used in combination. Preferably, not less than 1 part by mass and not more than 20 parts by mass of the mold release agent is added based on 100 parts by mass of the binder resin.

In the toner according to the present invention, a known other charge-controlling agent can be used in combination with the compound described above as the charge-controlling agent. Examples of the other charge-controlling agent include azo iron complexes or complex salts, azo chromium complexes or complex salts, azo manganese complexes or complex salts, azo cobalt complexes or complex salts, azo zirconium complexes or complex salts, chromium complexes of carboxylic acid derivatives or complex salts, zinc complexes of carboxylic acid derivatives or complex salts, aluminum complexes of carboxylic acid derivatives or complex salts, zirconium complexes of carboxylic acid derivatives or complex salts. As the carboxylic acid derivatives, preferred is aromatic hydroxycarboxylic acid. Charge-controlling resins can also be used. In a case where the charge-controlling agent used for the present invention is used in combination with the other charge-controlling agent, not less than 0.1 parts by mass and not more than 10 parts by mass of the other charge-controlling agent is preferably used based on 100 parts by mass of the binder resin.

The toner according to the present invention may be mixed with a carrier, and used as a two component developer. As the carrier, ordinary carriers such as ferrite and magnetite and resin-coated carriers can be used. Binder-type carrier cores can also be used in which magnetic powder is dispersed in a resin.

In the toner according to the present invention, in order to improve triboelectric charging stability, developing properties, fluidity, and durability, preferably, silica fine particles are externally added to the toner particles. The silica fine particles have a specific surface area of preferably not less than 30 m²/g, and more preferably not less than 50 m²/g and not more than 400 m²/g, the specific surface area being obtained by the BET method using nitrogen adsorption. The amount of the silica fine powder to be used is preferably not less than 0.01 parts by mass and not more than 8.00 parts by mass, and more preferably not less than 0.10 parts by mass and not more than 5.00 parts by mass based on 100 parts by mass of the toner particles. The BET specific surface area of the silica fine particles can be obtained as follow: using a specific surface area measurement apparatus Autosorb 1 (made by Yuasa Ionics K.K.), a GEMINI 2360/2375 (made by Micromeritics Instrument Corporation), or a TriStar 3000 (made by Micromeritics Instrument Corporation), for example, nitrogen gas is absorbed by the surfaces of the silica fine particles, and calculation is performed using a BET multi-point method.

Preferably, in order to control hydrophobization and triboelectric charging properties, the silica fine particles is treated with a treatment agent such as non-modified silicone varnishes, a variety of modified silicone varnishes, non-modified silicone oils, a variety of modified silicone oils, silane coupling agents, silane compounds having a functional group, or other organic silicon compounds, or in combination of a variety of treatment agents, when necessary.

Further, when necessary, other external additives may be added to the toner according to the present invention. Examples of such external additives include resin fine particles and inorganic fine powders serving as a charging aid, a conductivity agent, a fluidity agent, an anticaking agent, a mold release agent during heat roller fixing, a lubricant, and a polishing agent. Examples of the lubricant include fluoroethylene powder, zinc stearate powder, and polyvinylidene fluoride powder. Examples of the polishing agent include cerium oxide powder, silicon carbide powder, and strontium titanate powder. Among these, strontium titanate powder is preferred.

As the method for producing a toner, the following method can be used. A binder resin, a colorant, a charge-controlling agent, when necessary, wax and other additives are sufficiently mixed by a mixer such as a Henschel mixer and a ball mill. The mixture is melt kneaded using a heat kneader such as a twin screw kneading extruder, a heat roll, a kneader, and an extruder. At this time, wax, magnetic iron oxide particles, and a metal-containing compound can be added. The melt kneaded product is cooled and solidified, crushed, and classified to obtain toner particles. Further, when necessary, the toner particles and an external additive can be mixed by a mixer such as a Henschel mixer to obtain a toner.

Examples of the mixer include:

a Henschel mixer (made by Mitsui Mining Co., Ltd.); a SUPERMIXER (KAWATAMFG Co., Ltd.); a Ribocone (made by Okawara Mfg. Co., Ltd.); a Nauta Mixer, a Turbulizer, and a Cyclomix (made by Hosokawa Micron Corporation); a Spiral Spin Mixer (made by Pacific Machinery & Engineering Co., Ltd.); and a Loedige mixer (made by MATSUBO Corporation). Examples of the kneader include: a KRC kneader (made by Kurimoto, Ltd.); a Buss cokneader (made by Buss AG); a TEM-type extruder (made by TOSHIBA MACHINE CO., LTD.); a TEX twin screw kneader (made by The Japan Steel Works, LTD.); a PCM kneader (made by Ikegai Ironworks Corp.); a three-roll mill, a mixing roll mill, and a kneader (made by INOUE MANUFACTURING CO., LTD.); a Kneadex (made by Mitsui Mining Co., Ltd.); an MS-type Preddure Kneader, and a Kneader-ruder (made by Moriyama Mfg. Co.); and a Banbury mixer (made by Kobe Steel, Ltd.). Examples of the mill include: a Counter Jet Mill, a Micro Jet, and an Inomizer (made by Hosokawa Micron Corporation); an IDS-type Mill, and a PJM Jet Mill (made by Nippon Pneumatic Mfg. Co., Ltd.); a Cross Jet Mill (made by Kurimoto, Ltd.); an ULMAX (made by NISSO ENGINEERING CO., LTD.); an SK Jet-O-Mill (made by Seishin Enterprise Co., Ltd.); a CRYPTRON (made by Kawasaki Heavy Industries, Ltd.); a Turbo Mill (made by Turbo Kogyo Co., Ltd.); and a Super Rotor (made by NISSHIN ENGINEERING INC.).

Examples of the classifiers include: a Crushiel, a Micron classifier, a Spedic classifier (made by Seishin Enterprise Co., Ltd.); a Turbo classifier (made by NISSHIN ENGINEERING INC.); a Micron separator, a Turboplex (ATP), and a TSP Separator (made by Hosokawa Micron Corporation); an Erbojet (made by Nittetsu Mining Co., Ltd.); a Dispersion separator (made by Nippon Pneumatic Mfg. Co., Ltd.); and an Microcut (made by Yasukawa Trading Co.).

Examples of a sieving apparatus used for sieving coarse particles include: an Ultrasonic (made by Koei Sangyo Co., Ltd.); a Resonasieve and a Gyronshifter (made by TOKUJU CORPORATION); a Vibrasonic system (made by DALTON CORPORATION); a Sonicreen (made by SINTOKOGIO, LTD.); a Turbo Screeser (made by Turbo Kogyo Co., Ltd.); a Microshifter (made by Makino Mfg. Co., Ltd.); and a circular vibration sieve.

### EXAMPLES

Hereinafter, using Examples, the present invention will be specifically described. “Parts” in Examples represent parts by mass, unless otherwise specified.

### Production Example of Binder Resin (A-1)

Terephthalic acid: 45.0 mol parts
Fumaric acid: 2.0 mol parts
Ethylene glycol: 33.0 mol parts
Neopentyl glycol: 17.5 mol parts

The monomers were placed in a reaction tank including a cooling tube, a stirrer, and a nitrogen introduction pipe, and 1000 ppm of tetrabutoxytitanate based on the total acid components was added as a polymerization catalyst. Heating was performed to a temperature of 210° C., and the reaction was made for 5 hours under a nitrogen stream while water produced was removed. Then, the reaction was made for 1 hour under reduced pressure at 5 mmHg to 20 mmHg. Next, 2.5 mol parts of trimellitic anhydride was added, and the reaction was made for 1 hour under normal pressure. Then, the reaction was made under reduced pressure at 20 mmHg to 40 mmHg until the softening point reached a predetermined softening point.

The obtained resin was cooled to room temperature, and crushed into particles to obtain 7146 g of Binder Resin (A-1) comprising a polyester resin. Binder Resin (A-1) has a softening point (Tm) of 135° C. and a glass transition point (Tg) of 59° C. The composition ratio (mol parts) derived from the respective monomers used for producing Binder Resin (A-1) and values of physical properties are shown in Table 2. The composition ratio of the binder resin derived from the respective monomers was determined using 1H-NMR and 13C-NMR.

The measurement conditions on 1H-NMR and 13C-NMR are as follows:

(Measurement of 1H-NMR (nuclear magnetic resonance) spectrum)

Measurement apparatus: FT NMR apparatus JNM-EX400 (made by JEOL, Ltd.)

Measurement frequency: 400 MHz

Pulse condition: 5.0 μs

Data point: 32768

Frequency range: 10500 Hz

The number of integration: 10000 times

Measurement temperature: 60° C.

Sample: 50 mg of a sample to be measured is placed in a sample tube having a diameter of 5 mm, and CDCl₃ is added as a solvent; this is dissolved in a thermostat at a temperature of 60° C. to prepare a sample.

(Measurement of 13C-NMR (nuclear magnetic resonance) spectrum)

Measurement apparatus: FT NMR apparatus JNM-EX400 (made by JEOL, Ltd.)

Measurement frequency: 400 MHz

Pulse condition: 5.0 μs

Data points: 32768

Delay time: 25 sec.

Frequency range: 10500 Hz

The number of integration: 16 times

Measurement temperature: 40° C.

Sample: 200 mg of a sample to be measured is placed in a sample tube having a diameter of 5 mm, and CDCl₃ (0.05% of TMS) is added as a solvent; this is dissolved in a thermostat at a temperature of 40° C.

From the composition ratio derived from the respective monomers used for producing Binder Resin (A-1) and the weight (Q) (7146 g) of obtained Binder Resin (A-1), the mass (P) of each of the monomers was calculated, considering dehydration in the ester reaction. Then, the number of moles and the number of equivalents of the functional group in the respective monomers were calculated as in Table 1 below.

TABLE 1

| | | | Molecular | The | The number | The number |
|---|---|---|---|---|---|---|
| | | Mass of | weight of | number | of functional | of equivalents |
| | | monomer | monomer | of moles | group per | of functional |
| | | (P) | (R) | (P/R) | molecule | group |
| Acid | Terephthalic | 5229.77 | 166.13 | 31.48 | 2 | 62.96 |
| component | acid | | | | | |
| | Fumaric acid | 149.73 | 116.07 | 1.29 | 2 | 2.58 |
| | Trimellitic | 318.94 | 192.13 | 1.66 | 3 | 4.98 |
| | anhydride | | | | | |
| Alcohol | Ethylene | 1440.02 | 62.07 | 23.20 | 2 | 46.40 |
| component | glycol | | | | | |
| | Neopentyl | 1276.88 | 104.15 | 12.26 | 2 | 24.52 |
| | glycol | | | | | |

As shown in Table 1, the total number of equivalents of the carboxyl group in the acid component is smaller than the total number of equivalents of the hydroxyl group in the alcohol component. Accordingly, for each of the three monomers in the acid component, the mass of the monomer, the molecular weight of the monomer, the number of the functional group, and the mass of the produced binder resin were substituted into the expression for calculating the concentration of the ester group, and the concentration of the ester group was calculated (see the expression below). As a result, the concentration of the ester group in Binder Resin (A-1) was 43.4% by mass.

$$Concentration of ester group ( \% by mass ) = \frac{\{ ( 31.48 \times 2 ) + ( 1.29 \times 2 ) + ( 1.66 \times 3 ) \} \times 44}{7146} \times 100$$

### Production Example of Binder Resin (A-2)

In Production Example of Binder Resin (A-1) comprising the polyester resin, the monomers for producing the binder resin were changed as shown below. Except that, in the same manner as in Production Example of Binder Resin (A-1), Binder Resin (A-2) was obtained. The composition ratio (mol parts) derived from the respective monomers used for producing Binder Resin (A-2) and values of physical properties are shown in Table 2.
Terephthalic acid: 45.0 mol parts
Fumaric acid: 2.0 mol parts
Ethylene glycol: 14.0 mol parts
Neopentyl glycol: 9.5 mol parts
1,4-Cyclohexanedimethanol: 27.0 mol parts

### Production Example of Binder Resin (A-3)

The monomers used for producing the binder resin in Production Example of Binder Resin (A-1) were changed as follows. Except that, in the same manner as in Production Example of Binder Resin (A-1), Binder Resin (A-3) was obtained. The composition ratio (mol parts) derived from the respective monomers used for producing Binder Resin (A-3) and values of physical properties are shown in Table 2.
Terephthalic acid: 39.0 mol parts
Fumaric acid: 6.0 mol parts
Ethylene glycol: 32.0 mol parts
1,4-Cyclohexanedimethanol: 19.0 mol parts
Trimellitic anhydride: 4.0 mol parts

### Production Example of Binder Resin (A-4)

Terephthalic acid: 50.0 mol parts
Ethylene glycol: 35.0 mol parts
Neopentyl glycol: 15.0 mol parts

The monomers were placed in the reaction tank including a cooling tube, a stirrer, and a nitrogen introduction pipe, and 1000 ppm of tetrabutoxytitanate based on the total acid component was added as a polymerization catalyst. Heating was performed to a temperature of 210° C., and the reaction was made for 5 hours under nitrogen stream while water produced was removed. Then, the reaction was made for 1 hour under reduced pressure at 5 mmHg to 20 mmHg. Then, the reaction was made under reduced pressure at 20 mmHg to 40 mmHg until the softening point reached to a predetermined softening point. The obtained resin was cooled to room temperature, and crushed into particles to obtain Binder Resin (A-4). The composition ratio (mol parts) derived from the respective monomers used for producing Binder Resin (A-4) and values of physical properties are shown in Table 2.

### Production Example of Binder Resin (A-5)

The monomers used for producing the binder resin in Production Example of Binder Resin (A-4) were changed as follows. Except that, in the same manner as in Production Example of Binder Resin (A-1), Binder Resin (A-5) was obtained. The composition ratio (mol parts) derived from the respective monomers used for producing Binder Resin (A-5) and values of physical properties are shown in Table 2.
Terephthalic acid: 48.0 mol parts
Fumaric acid: 2.0 mol parts
1,2-Propanediol derived from biomass: 20.0 mol parts
(The raw material is derived from corn)
Ethylene glycol: 15.0 mol parts
Neopentyl glycol: 15.0 mol parts

### Production Example of Binder Resin (A-6)

The monomers used for producing the binder resin in Production Example of Binder Resin (A-1) were changed as follows. Except that, Binder Resin (A-6) was obtained in the same manner as in Example Production of Polyester Resin (A-1). The composition ratio (mol parts) derived from the respective monomers used for producing Binder Resin (A-6) and values of physical properties are shown in Table 2.
Terephthalic acid: 40.0 mol parts
Fumaric acid: 6.0 mol parts
Ethylene glycol: 24.5 mol parts
1,2-Propanediol derived from biomass: 10.0 mol parts
(The raw material is derived from corn)
1,4-Cyclohexanedimethanol: 16.0 mol parts
Trimellitic anhydride: 3.5 mol parts

### Production Example of Binder Resin (A-7)

The monomers used for producing the binder resin in Production Example of Binder Resin (A-1) were changed as follows. Except that, in the same manner as in Production Example of Binder Resin (A-1), Binder Resin (A-7) was obtained. The composition ratio (mol parts) derived from the respective monomers used for producing Binder Resin (A-7) and values of physical properties are shown in Table 2.
Terephthalic acid: 47.0 mol parts
Ethylene glycol: 42.0 mol parts
Bisphenol A-propylene oxide 2.2 mol adduct: 8.5 mol parts

### Production Example of Binder Resin (A-8)

The monomers used for producing the binder resin in Production Example of Binder Resin (A-1) were changed as follows. Except that, in the same manner as in Production Example of Binder Resin (A-1), Binder Resin (A-8) was obtained. The composition ratio (mol parts) derived from the respective monomers used for producing Binder Resin (A-8) and values of physical properties are shown in Table 2.
Terephthalic acid: 44.0 mol parts
1,4-Cyclohexanedimethanol: 38.0 mol parts
2.2 mol of Propylene oxide adduct of bisphenol A: 15.0 mol parts
Trimellitic anhydride: 3.0 mol parts

### Production Example of Binder Resin (A-9)

The monomers used for producing the binder resin in Production Example of Binder Resin (A-1) were changed as follows. Except that, in the same manner as in Production Example of Binder Resin (A-1), Binder Resin (A-9) was obtained. The composition ratio (mol parts) derived from the respective monomers used for producing Binder Resin (A-9) and values of physical properties are shown in Table 2.
Terephthalic acid: 12.0 mol parts
Fumaric acid: 35.0 mol parts
Ethylene glycol: 44.5 mol parts
Neopentyl glycol: 6.0 mol parts

### Production Example of Binder Resin (A-10)

The monomers in the binder resin in Production Example of Binder Resin (A-1) were changed as follows. Except that, in the same manner as in Production Example of Resin (A-1), Binder Resin (A-10) was obtained. The composition ratio (mol parts) derived from the respective monomers used for producing Binder Resin (A-10) and values of physical properties are shown in Table 2.
Fumaric acid: 47.0 mol parts
Ethylene glycol: 50.5 mol parts

### Production Example of Binder Resin (A-11)

The monomers used for producing the binder resin in Production Example of Binder Resin (A-1) were changed as follows. Except that, in the same manner as in Production Example of Binder Resin (A-1), Binder Resin (A-11) was obtained. The composition ratio (mol parts) derived from the respective monomers used for producing Binder Resin (A-11) and values of physical properties are shown in Table 2.
Terephthalic acid: 45.0 mol parts
Ethylene glycol: 36.5 mol parts
2.2 mol of Propylene oxide adduct of bisphenol A: 16.0 mol parts

### Production Example of Binder Resin (A-12)

The monomers used for producing the binder resin in Production Example of Binder Resin (A-1) were changed as follows. Except that, in the same manner as in Production Example of Binder Resin (A-1), Binder Resin (A-12) was obtained. The composition ratio (mol parts) derived from the respective monomers used for producing Binder Resin (A-12) and values of physical properties are shown in Table 2.
Terephthalic acid: 45.5 mol parts
2.2 mol of Propylene oxide adduct of bisphenol A: 52.0 mol parts

### Production Example of Binder Resin (A-13)

The monomers used for producing the binder resin in Production Example of Binder Resin (A-1) were changed as follows. Except that, in the same manner as in Production Example of Binder Resin (A-1), Binder Resin (A-13) was obtained. The composition ratio (mol parts) derived from the respective monomers used for producing Binder Resin (A-13) and values of physical properties are shown in Table 2.
Terephthalic acid: 46.5 mol parts
2.2 mol of Propylene oxide adduct of bisphenol A: 23.0 mol parts
1,4-Cyclohexanedimethanol: 28.0 mol parts

TABLE 2

| Binder resin No. | | A-1 | A-2 | A-3 | A-4 | A-5 | A-6 | A-7 |
|---|---|---|---|---|---|---|---|---|
| Acid | Terephthalic acid | 45.0 | 44.8 | 39.2 | 49.8 | 47.8 | 39.2 | 46.7 |
| component | Fumaric acid | 1.8 | 2.2 | 6.0 | — | 2.0 | 6.0 | — |
| | Trimellitic acid | 2.4 | 2.3 | 3.5 | — | — | 3.5 | 2.4 |
| Alcohol | Ethylene glycol | 33.2 | 14.1 | 32.2 | 35.1 | 15.1 | 25.1 | 42.4 |
| component | NPG¹⁾ | 17.5 | 9.9 | — | 15.2 | 15.1 | — | — |
| | 1,4-CHDM²⁾ | — | 26.8 | 19.1 | — | — | 16.1 | — |
| | BPA-PO³⁾ | — | — | — | — | — | — | 8.6 |
| | 1,2-Propanediol | — | — | — | — | 20.1 | 10.1 | — |
| Values of | Proportion of aliphatic | 100 | 100 | 100 | 100 | 100 | 100 | 83.2 |
| physical | polyalcohol in alcohol | | | | | | | |
| properties | component (mol %) | | | | | | | |
| | Concentration of ester | 43.4 | 36.7 | 41.1 | 42.8 | 42.0 | 41.5 | 36.7 |
| | group (%) | | | | | | | |
| | Tm (° C.) | 135 | 137 | 145 | 112 | 109 | 142 | 139 |
| | Tg (° C.) | 59 | 61 | 65 | 55 | 54 | 61 | 62 |

| Binder resin No. | | A-8 | A-9 | A-10 | A-11 | A-12 | A-13 |
|---|---|---|---|---|---|---|---|
| Acid | Terephthalic acid | 44.6 | 12.3 | — | 45.2 | 46.5 | 46.3 |
| component | Fumaric acid | — | 34.5 | 46.8 | — | — | — |
| | Trimellitic acid | 3.0 | 2.5 | 2.5 | 2.5 | 2.3 | 2.8 |
| Alcohol | Ethylene glycol | — | 44.8 | 50.7 | 36.2 | — | — |
| component | NPG¹⁾ | — | 5.9 | — | — | — | — |
| | 1,4-CHDM²⁾ | 37.6 | — | — | — | — | 27.8 |
| | BPA-PO³⁾ | 14.9 | — | — | 16.1 | 51.2 | 23.2 |
| | 1,2-Propanediol | — | — | — | — | — | — |
| Values of | Proportion of aliphatic | 71.7 | 100 | 100 | 69.2 | 0 | 54.5 |
| physical | polyalcohol in alcohol | | | | | | |
| properties | component (mol %) | | | | | | |
| | Concentration of ester | 25.7 | 54.8 | 61.0 | 30.4 | 17.9 | 24.5 |
| | group (%) | | | | | | |
| | Tm (° C.) | 138 | 128 | 128 | 135 | 137 | 138 |
| | Tg (° C.) | 63 | 54 | 54 | 61 | 62 | 61 |

¹⁾Neopentyl glycol
²⁾1,4-Cyclohexanedimethanol
³⁾2.2 mol of propylene oxide adduct of bisphenol A

### Production Example of Binder Resin (B-1)

95 parts by mass (47.5 kg) of L-lactide and 5 parts by mass (2.5 kg) of D-lactide were placed in a polymerization reaction tank. While L-lactide and D-lactide were stirred under a nitrogen atmosphere, L-lactide and D-lactide were heated and molten, and uniformly mixed. Next, 0.03 parts (15 g) of tin octylate was added, and the temperature was heated to 190° C. to perform a heat ring-opening polymerization until the softening point reached a predetermined softening point. Thus, biomass-derived Binder Resin (B-1) was obtained. The concentration of the ester group of Binder Resin (B-1) was 48.9%, the softening point (Tm) was 131° C., and the glass transition point (Tg) was 68° C.

### Production Example of Binder Resin (B-2)

Terephthalic acid: 24 mol parts
Dodecenylsuccinic acid: 16 mol parts
Trimellitic acid: 7 mol parts
Bisphenol derivative represented by the following formula (I-1): 31 mol parts
(2.5 mol adduct of propylene oxide)
bisphenol derivative represented by the following formula (I-1): 22 mol parts
(2.5 mol adduct of ethylene oxide)

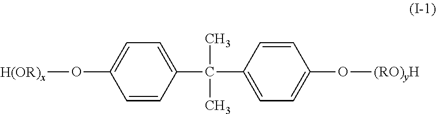

wherein R represents an ethylene or propylene group, x and y each are an integer of 1 or more, and the average value of x+y is 2 to 10.

The raw material and tin 2-ethylhexanoate as a catalyst were placed in a four-neck flask, and a pressure reducing apparatus, a water separating apparatus, a nitrogen gas introducing apparatus, a temperature measurement apparatus, and a stirrer were attached. While stirring was performed under a nitrogen atmosphere at a temperature of 130° C., 25 parts by mass of the monomers for producing a styrene-acrylic resin unit shown below were added based on 100 parts by mass of the raw material. At this time, the monomer below were mixed with a polymerization initiator (benzoyl peroxide), and dropped from a dropping funnel over 4 hours.
Styrene: 82 parts by mass
2-Ethylhexylacrylate: 16 parts by mass
Acrylic acid: 2 parts by mass

The product was aged for 3 hours while the temperature thereof kept at 130° C. The temperature was raised to 230° C. to make the reaction. After the reaction was terminated, the product was extracted from the container, and crushed to obtain Binder Resin (B-2). Binder Resin (B-2) contains a polyester resin component, a vinyl polymer component, and a hybrid resin component having a polyester unit chemically bonded to a styrene-acrylic resin unit. The softening point was 131° C., and the glass transition point was 65° C.

### Production Example of Charge-Controlling Agent (C-1)

10 parts of 4-chloro-2-aminophenol was added to a mixed solution of 76.5 parts of water and 15.2 parts of 35% hydrochloric acid, and stirred under cooling. The mixed solution was cooled with ice, and the temperature of the solution was kept so that the temperature was 0° C. to 5° C. 13.6 parts of sodium nitrite dissolved in 24.6 parts of water was dropped into a hydrochloric acid aqueous solution, and stirred for 2 hours to be diazotized. Excessive nitrous acid was eliminated with sulfamic acid, and the filtration was performed to obtain a diazo solution.

Next, 12.0 parts of 3-methyl-1-(3,4-dichlorophenyl)-5-pyrazolone was added to a mixed solution of 87 parts of water, 12.1 parts of 25% sodium hydroxide, 4.9 parts of sodium carbonate, and 104.6 parts of n-butanol, and dissolved. The diazo solution was added to the mixed solution, and stirred at a temperature of 20° C. to 22° C. for 4 hours to make a coupling reaction. Subsequently, 92.8 parts of water and 43.5 parts of a 25% sodium hydroxide aqueous solution were added, stirred, and washed to separate and remove a lower aqueous layer.

Next, 42.2 parts of water, 5.9 parts of salicylic acid, 24.6 parts of butanol, and 48.5 parts of 15% sodium carbonate were added to the reaction solution, and stirred. Further, 15.1 parts of a 38% ferric chloride aqueous solution and 18.0 parts of 15% sodium carbonate were added, and the pH of the reaction solution was adjusted with acetic acid at 4.5. The temperature of the solution was raised to a temperature of 30° C., and the solution was stirred for 8 hours to make a complexation reaction. After stirring was stopped, the solution was left as it was, and the lower aqueous layer was separated. Further, 189.9 parts of water was added, stirred, and washed to separate and remove the lower aqueous layer. After filtration, the cake was washed with 253 parts of water. The cake was dried in vacuum at a temperature of 60° C. for 24 hours to obtain Charge-Controlling Agent (C-1) that is a monoazo metal complex compound.

By infrared absorption spectrometry, visible absorption spectrometry, element analysis (C, H, and N), atomic absorption spectrometry, and mass spectrometry, the structure of Charge-Controlling Agent (C-1) was identified. The structure of Charge-Controlling Agent (C-1) is shown in Table 3. The bonding parts of substituents A₁, A₂, and A₃ in Table 3 correspond to the numerals in the following formula (1).

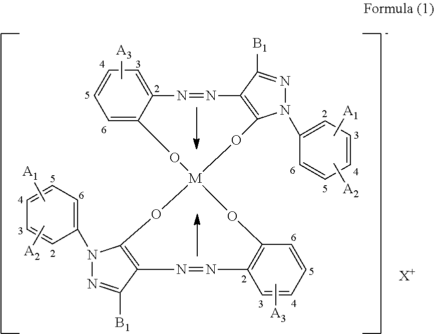

Moreover, the amount of moisture to be adsorbed and Δ(M2−M1) of Charge-Controlling Agent (C-1) at a temperature of 30° C. and a humidity of 90% RH is shown in Table 3.

The amount of moisture to be adsorbed by the charge-controlling agent was measured using a “high precision steam adsorption amount measurement apparatus BELSORP-aqua 3” (BEL Japan, Inc.). The “high precision steam adsorption amount measurement apparatus BELSORP-aqua 3” provides solid-gas equilibrium under the condition in which only a target gas (water in the case of the present invention) exists, and measures the mass of the solid and the vapor pressure at this time.

First, about 1 g of a sample was introduced into a sample cell, and degassing was performed under room temperature at not more than 100 Pa for 24 hours.

After degassing was completed, the weight of the sample was precisely weighed. The sample was set in the main body of the apparatus, and measured on the following condition.
Air thermostat temperature: 80.0° C.
Adsorption temperature: 30.0° C.
Name of adsorbate: H₂O
Equilibrium time: 500 sec
Temperature waiting: 60 min
Saturated vapor pressure: 4.245 kPa
Discharging rate of air in the sample tube: normal
Initial amount of introduced pressure to be introduced: 0.20 cm³ (STP)·g⁻¹
Measurement relative pressure P/P0 (the adsorption process to the desorption process is measured): 0.05, 0.15, 0.25, 0.35, 0.45, 0.55, 0.65, 0.75, 0.85, 0.90, and 0.95

The measurement was performed on the condition above, moisture adsorption and desorption isotherms at a temperature of 30° C. was drawn, and the amount of moisture to be adsorbed (mg/g) in the adsorption process at a humidity of 90% RH was calculated. Moreover, the difference Δ(M2−M1) between the amount of moisture to be adsorbed M1 (mg/g) in the adsorption process at a humidity of 65% RH and the amount of moisture to be adsorbed M2 (mg/g) in the desorption process having humidity history up to the humidity of 95% RH was calculated.

### Production Example of Charge-Controlling Agent (C-2)

In Production Example of Charge-Controlling Agent (C-1), 42.2 parts of water, 5.9 parts of salicylic acid, 24.6 parts of n-butanol, and 48.5 parts of 15% sodium carbonate were added to the reaction solution after the coupling reaction was terminated, and stirred. Further, 15.1 parts of a 38% ferric chloride aqueous solution and 48.5 parts of 15% sodium carbonate were added, and the temperature was raised to 30° C. Then, the reaction solution was stirred for 8 hours to make a complexation reaction. After stirring was stopped, the solution was left as it was, and the lower aqueous layer was separated. Further, 92.8 parts of water, 12.3 parts of n-butanol, and 8.7 parts of 25% sodium hydroxide were added, stirred, and washed to separate and remove the lower aqueous layer. Filtration was performed to extract a metal complex compound, and the compound was washed with 253 parts of water.

5.9 parts of sodium hydroxide was added to 82.3 parts of water, and stirred while the temperature was raised. When the inner temperature reached a temperature of 90° C., a mixed solution prepared by dispersing the metal complex compound in 113.9 parts of water was dropped with a pipette. Stirring was performed for 1 hour at a temperature of not less than 97° C. and not more than 99° C. while n-butanol was distilled. After cooling and filtration, the cake was washed with 253 parts of water. The cake was dried in vacuum at a temperature of 60° C. for 24 hours to obtain Charge-Controlling Agent (C-2) that is a monoazo metal complex compound.

By infrared absorption spectrometry, visible absorption spectrometry, element analysis (C, H, and N), atomic absorption spectrometry, and mass spectrometry, the structure of Charge-Controlling Agent (C-2) was identified. The structure of Charge-Controlling Agent (C-2) is shown in Table 3. Moreover, the amount of moisture to be adsorbed and Δ(M2−M1) at a temperature of 30° C. and a humidity of 90% RH in Charge-Controlling Agent (C-2) are shown in Table 3.

### Production Example of Charge-Controlling Agent (C-3)

Sodium hydroxide used as the solution to react with the metal complex compound in Production Example of Charge-Controlling Agent (C-2) was replaced by ammonium sulfate. Except that, in the same manner as in Production Example of Charge-Controlling Agent (C-2), Charge-Controlling Agent (C-3) that is a monoazo metal complex compound was obtained.

By infrared absorption spectrometry, visible absorption spectrometry, element analysis (C, H, and N), atomic absorption spectrometry, and mass spectrometry, the structure of Charge-Controlling Agent (C-3) was identified. The structure of Charge-Controlling Agent (C-3) is shown in Table 3. Moreover, the amount of moisture to be adsorbed and Δ(M2−M1) at a temperature of 30° C. and a humidity of 90% RH in Charge-Controlling Agent (C-3) are shown in Table 3.

### Production Example of Charge-Controlling Agent (C-4)

Sodium hydroxide used as the solution to react with the metal complex compound in Production Example of Charge-Controlling Agent (C-2) was replaced by tetrabutylammonium bromide. Except that, in the same manner as in Production Example of Charge-Controlling Agent (C-2), Charge-Controlling Agent (C-4) that is a monoazo metal complex compound was obtained.

By infrared absorption spectrometry, visible absorption spectrometry, element analysis (C, H, and N), atomic absorption spectrometry, and mass spectrometry, the structure of Charge-Controlling Agent (C-4) was identified. The structure of Charge-Controlling Agent (C-4) is shown in Table 3. Moreover, the amount of moisture to be adsorbed and Δ(M2−M1) at a temperature of 30° C. and a humidity of 90% RH in Charge-Controlling Agent (C-4) are shown in Table 3.

### Production Example of Charge-Controlling Agent (C-5)

Sodium hydroxide used as the solution to react with the metal complex compound in Production Example of Charge-Controlling Agent (C-2) was replaced by potassium hydroxide. Except that, in the same manner as in Production Example of Charge-Controlling Agent (C-2), Charge-Controlling Agent (C-5) that is a monoazo metal complex compound was obtained.

By infrared absorption spectrometry, visible absorption spectrometry, element analysis (C, H, and N), atomic absorption spectrometry, and mass spectrometry, the structure of Charge-Controlling Agent (C-5) was identified. The structure of Charge-Controlling Agent (C-5) is shown in Table 3. Moreover, the amount of moisture to be adsorbed and Δ(M2−M1) at a temperature of 30° C. and a humidity of 90% RH in Charge-Controlling Agent (C-5) are shown in Table 3.

### Production Example of Charge-Controlling Agent (C-6)

The amount of ammonium sulfate used in Production Example of Charge-Controlling Agent (C-3) was reduced to a half thereof. Except that, in the same manner as in Production Example of Charge-Controlling Agent (C-3), Charge-Controlling Agent (C-6) that is a monoazo metal complex compound was obtained.

By infrared absorption spectrometry, visible absorption spectrometry, element analysis (C, H, and N), atomic absorption spectrometry, and mass spectrometry, the structure of Charge-Controlling Agent (C-6) was identified. The structure of Charge-Controlling Agent (C-6) is shown in Table 3. Moreover, the amount of moisture to be adsorbed and Δ(M2−M1) at a temperature of 30° C. and a humidity of 90% RH in Charge-Controlling Agent (C-6) are shown in Table 3.

### Production Example of Charge-Controlling Agent (C-7)

3-Methyl-1-(3,4-dichlorophenyl)-5-pyrazolone in Production Example of Charge-Controlling Agent (C-1) was replaced by 3-methyl-1-phenyl-5-pyrazolone. Except that, in the same manner as in Production Example of Charge-Controlling Agent (C-1), Charge-Controlling Agent (C-7) that is a monoazo metal complex compound was obtained.

By infrared absorption spectrometry, visible absorption spectrometry, element analysis (C, H, and N), atomic absorption spectrometry, and mass spectrometry, the structure of Charge-Controlling Agent (C-7) was identified. The structure of Charge-Controlling Agent (C-7) is shown in Table 3. Moreover, the amount of moisture to be adsorbed and Δ(M2−M1) at a temperature of 30° C. and a humidity of 90% RH in Charge-Controlling Agent (C-7) are shown in Table 3.

### Production Example of Charge-Controlling Agent (C-8)

3-Methyl-1-(3,4-dichlorophenyl)-5-pyrazolone in Production Example of Charge-Controlling Agent (C-1) was replaced by 3-methyl-1-(3,4-dinitrophenyl)-5-pyrazolone. Except that, in the same manner as in Production Example of Charge-Controlling Agent (C-1), Charge-Controlling Agent (C-8) that is a monoazo metal complex compound was obtained.

By infrared absorption spectrometry, visible absorption spectrometry, element analysis (C, H, and N), atomic absorption spectrometry, and mass spectrometry, the structure of Charge-Controlling Agent (C-8) was identified. The structure of Charge-Controlling Agent (C-8) is shown in Table 3. Moreover, the amount of moisture to be adsorbed and Δ(M2−M1) at a temperature of 30° C. and a humidity of 90% RH in Charge-Controlling Agent (C-8) are shown in Table 3.

### Production Example of Charge-Controlling Agent (C-9)

4-Chloro-2-aminophenol in Production Example of Charge-Controlling Agent (C-7) was replaced by 4-nitro-2-aminophenol. Except that, in the same manner as in Production Example of Charge-Controlling Agent (C-7), Charge-Controlling Agent (C-9) that is a monoazo metal complex compound was obtained.

By infrared absorption spectrometry, visible absorption spectrometry, element analysis (C, H, and N), atomic absorption spectrometry, and mass spectrometry, the structure of Charge-Controlling Agent (C-9) was identified. The structure of Charge-Controlling Agent (C-9) is shown in Table 3. Moreover, the amount of moisture to be adsorbed and Δ(M2−M1) at a temperature of 30° C. and a humidity of 90% RH in Charge-Controlling Agent (C-9) are shown in Table 3.

### Production Example of Charge-Controlling Agent (C-10)

The ferric chloride aqueous solution used for metallization in Production Example of Charge-Controlling Agent (C-7) was replaced by a chromium sulfate aqueous solution. Except that, in the same manner as in Production Example of Charge-Controlling Agent (C-7), Charge-Controlling Agent (C-10) that is a monoazo metal complex compound was obtained.

By infrared absorption spectrometry, visible absorption spectrometry, element analysis (C, H, and N), atomic absorption spectrometry, and mass spectrometry, the structure of Charge-Controlling Agent (C-10) was identified. The structure of Charge-Controlling Agent (C-10) is shown in Table 3. Moreover, the amount of moisture to be adsorbed and Å(M2−M1) at a temperature of 30° C. and a humidity of 90% RH in Charge-Controlling Agent (C-10) are shown in Table 3.

### Production Example of Charge-Controlling Agent (C-11)

The ferric chloride aqueous solution used for metallization in Production Example of Charge-Controlling Agent (C-7) was replaced by an aluminium chloride aqueous solution. Except that, in the same manner as in Production Example of Monoazo Metal Complex Compound (C-7), Charge-Controlling Agent (C-11) that is a monoazo metal complex compound was obtained.

By infrared absorption spectrometry, visible absorption spectrometry, element analysis (C, H, and N), atomic absorption spectrometry, and mass spectrometry, the structure of Charge-Controlling Agent (C-11) was identified. The structure of Charge-Controlling Agent (C-11) is shown in Table 3. Moreover, the amount of moisture to be adsorbed and Δ(M2−M1) at a temperature of 30° C. and a humidity of 90% RH in Charge-Controlling Agent (C-11) are shown in Table 3.

TABLE 3

| | | | | | | | | | | Amount of | |
|---|---|---|---|---|---|---|---|---|---|---|---|
| Charge- | | | | | | | | | | moisture to | |
| controlling | | A₁ | | A₂ | | A₃ | | | | be adsorbed | Δ(M2- |
| agent | | Bonding | Substi- | Bonding | Substi- | Bonding | Substi- | | | at 90 RH % | M1) at 65 |
| No | M | part | tuent | part | tuent | part | tuent | B₁ | X⁺ | mg/g | RH % |
| C-1 | Fe | 3 | Cl | 4 | Cl | 4 | Cl | CH₃ | H | 5.72 | 0.244 |
| C-2 | Fe | 3 | Cl | 4 | Cl | 4 | Cl | CH₃ | Na | 6.62 | 0.289 |
| C-3 | Fe | 3 | Cl | 4 | Cl | 4 | Cl | CH₃ | NH₄ | 6.37 | 0.293 |
| C-4 | Fe | 3 | Cl | 4 | Cl | 4 | Cl | CH₃ | (Bu)₄N | 7.42 | 0.334 |
| C-5 | Fe | 3 | Cl | 4 | Cl | 4 | Cl | CH₃ | K | 7.12 | 0.309 |
| C-6 | Fe | 3 | Cl | 4 | Cl | 4 | Cl | CH₃ | NH₄, Na, H | 7.33 | 0.363 |
| C-7 | Fe | — | H | — | H | 4 | Cl | CH₃ | H | 19.77 | 2.613 |
| C-8 | Fe | 3 | NO₂ | 4 | NO₂ | 4 | Cl | CH₃ | H | 23.57 | 3.312 |
| C-9 | Fe | — | H | — | H | 4 | NO₂ | H | H | 22.34 | 3.642 |
| C-10 | Cr | — | H | — | H | 4 | Cl | CH₃ | H | 20.20 | 2.533 |
| C-11 | Al | — | H | — | H | 4 | Cl | CH₃ | H | 21.16 | 3.128 |

*C-1 to C-11 are represented by the structure of the formula (1). Moreover, M, A₁, A₂, A₃, B₁, and X⁺ in Table 2 correspond to M, A₁, A₂, A₃, B₁, and X⁺ in the formula (1).

### Example 1

Binder Resin (A-1): 100 parts by mass
Magnetic iron oxide particles: 90 parts by mass (average particle size=0.20 μm, Hc=11.5 kA/m, σs=85 Am²/kg, σr=16 Am²/kg)
Fischer-Tropsch wax (made by Sasol Wax GmbH, C105, melting point of 105° C.): 2 parts by mass
Charge-Controlling Agent (C-1): 2 parts by mass

The materials were pre-mixed by a Henschel mixer. Then, using a PCM-30 (made by Ikegai Ironworks Corp.), the temperature was set so that the temperature of the molten product at an outlet was 150° C., and the materials were melt kneaded. The obtained kneaded product was cooled, and crushed by a hammer mill. Then, the crushed product was pulverized using a Turbo Mill T250 (made by Turbo Kogyo Co., Ltd.). The obtained pulverized powder was classified using a multi classifier using a Coanda effect to obtain magnetic toner particles having a weight average particle size (D4) of 6.8 μm.

Next, to 100 parts by mass of the magnetic toner particles, 1.0 part by mass of hydrophobic silica fine powder (BET specific surface area of 150 m²/g, 100 parts of silica fine powder was hydrophobized with 30 parts of hexamethyldisilazane (HMDS) and 10 parts of dimethyl silicone oil), and 3.0 parts by mass of strontium titanate fine powder (D50:1.0 μm) were externally added, and sieved with a mesh having an opening of 150 μm to obtain Magnetic Toner 1. Obtained Magnetic Toner 1 was evaluated as follows. The results of evaluation are shown in Table 4.

<Evaluation of Low-Temperature Fixing Properties>

A fixing unit in a commercially available digital copier (image press 1135, made by Canon Inc.) was extracted to the outside, and an external fixing unit was used. The external fixing unit was modified so that the temperature of a fixing roller could be arbitrarily set, and the process speed was 850 mm/sec. Under a normal temperature and normal humidity environment (temperature of 23° C., humidity of 50% RH), the amount of the toner to be placed unit area was set at 0.5 mg/cm², a non-fixed image was fed to the fixing unit whose temperature was adjusted to 160° C. A recording medium used was a 90 m²/g paper. The obtained fixed image was rubbed by a silbond sheet to which a load of 4.9 kPa (50 g/cm²) was applied. The image was evaluated before and after rubbing according to the reduction rate of the image density (%).

A (very good): the reduction rate of the image density is less than 5%.

B (good): the reduction rate of the image density is not less than 5% and less than 10%.

C (fair): the reduction rate of the image density is not less than 10% and less than 20%.

D (bad): the reduction rate of the image density is not less than 20%.

<Evaluation of High-Temperature Offset Resistance>

Under a normal temperature and normal humidity environment (temperature of 23° C., humidity of 50% RH), on the condition of a process speed of 50 mm/sec, the temperature of the roller of 240° C., and a pressure to be applied of 50 kgf/cm², using a 50 g/m² paper, a non-fixed image having an image area rate of approximately 5% was fed, and a degree of dirt on the fixed image was examined. The evaluation criteria of the high-temperature offset resistance are as follows.

A (very good): dirt on the image due to offset is not found, and the image is good.

B (good): dirt on the image due to offset is slightly found.

C (fair): dirt on the image due to offset can be easily determined visually, but is not practically problematic.

D (bad): dirt on the image due to offset is entirely found, and quality of the image is problematic.

<Evaluation of Image>

Using an evaluation machine of a modified commercially available digital copier iR5075N (made by Canon Inc.) so as to have a fixing temperature of 160° C., under normal temperature and normal humidity environment (temperature of 23° C., humidity of 50% RH) and under a high temperature and high humidity environment (temperature of 30° C., humidity of 90% RH), 30,000 sheets of a test chart having a coverage rate of 5% were continuously printed. Then, evaluation was made about various items as follows.

Evaluation of Developing Properties (1)

The reduction rate of the image density after 30,000 sheets were printed to that when the 100th sheet was printed was calculated. As for the image density, using a Macbeth densitometer (Gretag Macbeth GmbH) as a reflection densitometer and an SPI filter, the reflection density of solid black portion in the image of the test chart was measured. The evaluation criteria are shown below.

A (very good): the reduction rate of the image density is less than 3.0%.

B (good): the reduction rate of the image density is not less than 3.0% and less than 6.0%.

C (fair): the reduction rate of the image density is not less than 6.0% and less than 10.0%.

D (bad): the reduction rate of the image density is not less than 10.0%.

Evaluation of Fogging

The worst value of a reflection density of a white portion in the image after a durability test of 30,000 sheets was Ds, a reflection average concentration of a transfer material before forming an image was Dr, and Dr−Ds was defined as a fogging value. The white portion reflection density was measured using a reflection densitometer (Reflectmeter Model TC-6DS, made by Tokyo Denshoku Co., Ltd.). A smaller numeric value indicates that the fogging is suppressed more significantly. The evaluation criteria are shown below.

A (very good): the fogging value is less than 1.0.

B (good): the fogging value is not less than 1.0 and less than 3.0.

C (fair): the fogging value is not less than 3.0 and less than 5.0.

D (bad): the fogging value is not less than 5.0.

Evaluation of Fixing Stability

While the 30,000 sheets were continuously printed, an all solid image (the leading margin: 5 mm) was output every 5000 sheets. The obtained fixed image was folded so that the image surface faced outwardly, and a degree of deficits of the image was visually determined. The evaluation was performed only under the normal temperature and normal humidity environment (temperature of 23° C., humidity of 50% RH). The evaluation criteria are shown below.

A (very good): the fixed image has no deficit.

B (good): slight deficits are found in the fold, but are not practically problematic.

C (fair): the image has clear deficits that can be visually observed.

D (bad): the image has remarkable deficits around the fold.

Evaluation of Developing Properties (2)

Toner (D-1) was left under a high temperature and high humidity (temperature of 30° C., humidity of 95% RH) environment for 24 hours. Subsequently, Toner (D-1) was further left under a high temperature and high humidity (temperature of 30° C., humidity of 65% RH) environment for 24 hours. Using the toner and the image evaluation machine, 30,000 sheets of the test chart having a coverage rate of 5% were continuously printed under the high temperature and high humidity (temperature of 30° C., humidity of 65% RH) environment. Then, the reduction rate of the image density was evaluated in the same manner as in Evaluation of developing properties (1).

In Example 1, good results were obtained in any of the evaluations.

### Examples 2 to 12

Magnetic Toners 2 to 12 were prepared in the same manner as in Example 1 except that the formula shown in Table 4 was used. The obtained magnetic toners were evaluated in the same manner as in Example 1. The results are shown in Table 4.

### Comparative Example 1

Comparative Magnetic Toner 1 was prepared in the same manner as in Example 1 except that an iron azo complex having the following structure (made by Hodogaya Chemical Co., Ltd., trade name: T-77) was used as Charge-Controlling Agent (C-12). In Charge-Controlling Agent (C-12), the amount of moisture to be adsorbed at a temperature of 30° C. and a humidity of 90% RH was 33.45 mg/g, and the difference Δ(M2−M1) between the amount of moisture to be adsorbed and desorbed at a humidity of 65% RH was 4.06. In the following formula, a+b+c is 1.

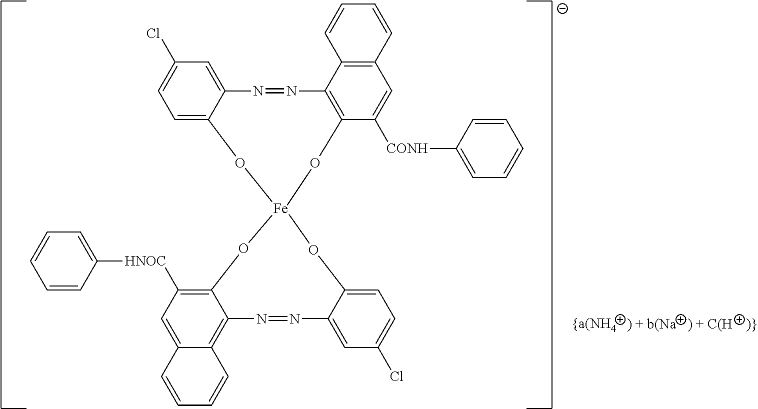

Obtained Comparative Magnetic Toner 1 was evaluated in the same manner as in Example 1. The results are shown in Table 4.

### Comparative Example 2

Comparative Magnetic Toner 2 was prepared in the same manner as in Example 1 except that a chromium azo complex having the following structure (made by Hodogaya Chemical Co., Ltd., trade name: T-95) was used as Charge-Controlling Agent (C-13). In Charge-Controlling Agent (C-13), the amount of moisture to be adsorbed at a temperature of 30° C. and a humidity of 90% RH was 34.27 mg/g, and the difference Δ(M2−M1) between the amount of moisture to be adsorbed and desorbed at a humidity of 65% RH was 4.92.

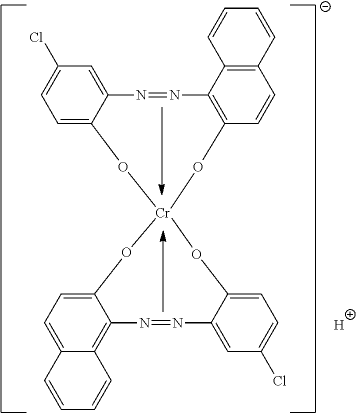

Obtained Comparative Magnetic Toner 2 was evaluated in the same manner as in Example 1. The results are shown in Table 4.

### Comparative Example 3 and, Comparative Example 4

Comparative Magnetic Toner 3 and Comparative Magnetic Toner 4 were prepared in the same manner as in Example 1 except that the formula shown in Table 4 was used. Obtained Comparative Magnetic Toners 3 and 4 were evaluated in the same manner as in Example 1. The results are shown in Table 4.

### Comparative Example 5

Comparative Magnetic Toner 5 was prepared in the same manner as in Example 1 except that a styrene-acrylic copolymer resin (made by Mitsui Chemicals, Inc., product name: CPR-100, softening point: 111° C.) was used as Binder Resin (B-3). Obtained Comparative Magnetic Toner 5 was evaluated in the same manner as in Example 1. The results are shown in Table 4.

TABLE 4

| Example/Comparative | | Example | | | | | | | | | |
|---|---|---|---|---|---|---|---|---|---|---|---|
| Example | | 1 | 2 | 3 | 4 | 5 | 6 | 7 | 8 | 9 | 10 |
| Toner | | Mag- | Mag- | Mag- | Mag- | Mag- | Mag- | Mag- | Mag- | Mag- | Mag- |
| | | netic | netic | netic | netic | netic | netic | netic | netic | netic | netic |
| | | toner 1 | toner 2 | toner 3 | toner 4 | toner 5 | toner 6 | toner 7 | toner 8 | toner 9 | toner 10 |
| Binder resin (1) | | A-1 | A-2 | A-4 | A-4 | A-5 | A-4 | A-2 | A-7 | A-7 | A-7 |
| Parts | | 100 | 100 | 70 | 50 | 70 | 70 | 100 | 100 | 100 | 100 |
| Binder resin (2) | | — | — | A-3 | B-2 | A-6 | B-1 | — | — | — | — |
| Parts | | | | 30 | 50 | 30 | 30 | | | | |
| Charge-controlling agent | | C-1 | C-2 | C-3 | C-1 | C-4 | C-5 | C-6 | C-7 | C-8 | C-9 |
| Evaluation | Low- | A | A | A | A | A | B | A | B | B | B |
| results | temperature | 2.5 | 4.7 | 3.1 | 3.9 | 3.7 | 7.2 | 4.7 | 6.5 | 6.9 | 7.1 |
| | fixing | | | | | | | | | | |
| | properties | | | | | | | | | | |
| | High- | A | B | A | A | A | A | B | A | A | A |
| | temperature | | | | | | | | | | |
| | offset | | | | | | | | | | |
| | resistance | | | | | | | | | | |
| | Evaluation | A | A | A | A | A | A | A | A | A | A |
| | of | 1.5 | 1.7 | 1.4 | 1.6 | 2.1 | 2.3 | 1.9 | 1.6 | 1.9 | 2.3 |
| | developing | | | | | | | | | | |
| | properties | | | | | | | | | | |
| | (1) | | | | | | | | | | |
| | (23° C./ | | | | | | | | | | |
| | 50 RH %) | | | | | | | | | | |
| | Evaluation | A | A | A | A | B | B | B | C | C | C |
| | of | 1.7 | 2.8 | 2.7 | 2.2 | 3.6 | 3.9 | 4.1 | 6.3 | 8.5 | 9.9 |
| | developing | | | | | | | | | | |
| | properties | | | | | | | | | | |
| | (1) | | | | | | | | | | |
| | (30° C./ | | | | | | | | | | |
| | 90 RH %) | | | | | | | | | | |
| | Fogging | A | A | A | A | A | A | A | A | A | A |
| | (23° C./ | 0.4 | 0.5 | 0.7 | 0.5 | 0.6 | 0.7 | 0.8 | 0.6 | 0.7 | 0.9 |
| | 50 RH %) | | | | | | | | | | |
| | Fogging | A | A | A | A | A | B | B | A | A | B |
| | (30° C./ | 0.5 | 0.4 | 0.7 | 0.4 | 0.9 | 1.3 | 1.4 | 0.8 | 0.9 | 2.9 |
| | 90 RH %) | | | | | | | | | | |
| | Fixing | A | A | A | A | A | B | A | B | B | B |
| | stability | | | | | | | | | | |
| | Evaluation | A | A | A | A | B | B | B | C | C | C |
| | of | 2.1 | 2.4 | 2.0 | 1.8 | 2.2 | 1.9 | 4.2 | 7.2 | 7.6 | 8.2 |
| | developing | | | | | | | | | | |
| | properties | | | | | | | | | | |
| | (2) | | | | | | | | | | |

| Example/Comparative | | Example | | Comparative Example | | | | |
|---|---|---|---|---|---|---|---|---|
| Example | | 11 | 12 | 1 | 2 | 3 | 4 | 5 |
| Toner | | Magnetic | Magnetic | Comparative | Comparative | Comparative | Comparative | Comparative |
| | | toner | toner | Magnetic | Magnetic | Magnetic | Magnetic | Magnetic |
| | | 11 | 12 | Toner 1 | Toner 2 | Toner 3 | Toner 4 | Toner 5 |
| Binder resin (1) | | A-8 | A-9 | A-10 | A-11 | A-12 | A-13 | B-3 |
| Parts | | 100 | 100 | 100 | 100 | 100 | 100 | 100 |
| Binder resin (2) | | — | — | — | — | — | — | — |
| Parts | | | | | | | | |
| Charge-controlling agent | | C-10 | C-11 | C-12 | C-13 | C-12 | C-12 | C-1 |
| Evaluation | Low- | C | A | A | D | D | D | D |
| results | temperature | 11.6 | 3.6 | 3.6 | 21.5 | 23.5 | 24.6 | 22.5 |
| | fixing | | | | | | | |
| | properties | | | | | | | |
| | High- | A | B | D | B | B | B | B |
| | temperature | | | | | | | |
| | offset | | | | | | | |
| | resistance | | | | | | | |
| | Evaluation | A | A | B | B | B | B | A |
| | of | 2.1 | 2.0 | 3.1 | 3.2 | 3.1 | 3.3 | 1.6 |
| | developing | | | | | | | |
| | properties | | | | | | | |
| | (1) | | | | | | | |
| | (23° C./ | | | | | | | |
| | 50 RH %) | | | | | | | |
| | Evaluation | C | C | D | D | D | D | A |
| | of | 6.4 | 7.5 | 10.2 | 10.5 | 12.4 | 12.4 | 2.0 |
| | developing | | | | | | | |
| | properties | | | | | | | |
| | (1) | | | | | | | |
| | (30° C./ | | | | | | | |
| | 90 RH %) | | | | | | | |
| | Fogging | A | A | B | B | B | B | A |
| | (23° C./ | 0.7 | 0.6 | 1.2 | 1.3 | 1.1 | 1.2 | 0.7 |
| | 50 RH %) | | | | | | | |
| | Fogging | B | C | B | D | B | B | A |
| | (30° C./ | 2.8 | 3.5 | 2.9 | 6.5 | 2.6 | 3.1 | 0.4 |
| | 90 RH %) | | | | | | | |
| | Fixing | C | A | A | D | D | D | D |
| | stability | | | | | | | |
| | Evaluation | C | C | D | D | D | D | A |
| | of | 8.4 | 9.5 | 10.9 | 11.5 | 12.2 | 13.2 | 2.3 |
| | developing | | | | | | | |
| | properties | | | | | | | |
| | (2) | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-072823, filed Mar. 29, 2011, which is hereby incorporated by reference herein in its entirety.

1. A toner having toner particles each of which comprises
a binder resin and a charge-controlling agent, wherein
the binder resin is a polyester resin obtained by condensation polymerization of an alcohol component containing not less than 70 mol % of an aliphatic polyalcohol with a carboxylic acid component,
the polyester resin has a concentration of an ester group of not less than 25% by mass and not more than 55% by mass, and
the charge-controlling agent is a compound represented by a following formula (1): 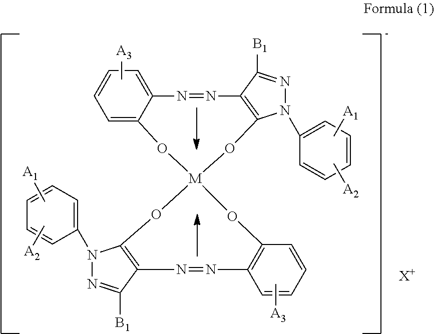
(wherein A₁, A₂, and A₃ each independently represent a hydrogen atom, a nitro group, or a halogen atom; B₁ represents a hydrogen atom or an alkyl group; M represents an Fe atom, a Cr atom, or an Al atom; X⁺ represents a hydrogen ion, an alkali metal ion, an ammonium ion, an alkylammonium ion, or mixed ions thereof.)

2. The toner according to claim 1, wherein the charge-controlling agent is a compound represented by a following formula (2): 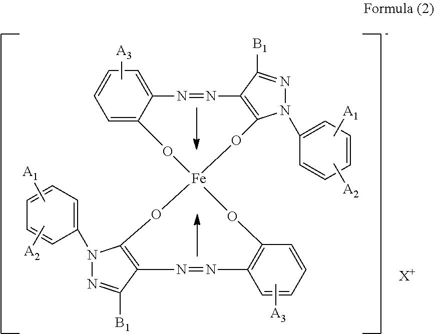
(wherein A₁, A₂, and A₃ each independently represent a hydrogen atom, a nitro group, or a halogen atom; B₁ represents a hydrogen atom or an alkyl group; X⁺ represents a hydrogen ion, an alkali metal ion, an ammonium ion, an alkylammonium ion, or mixed ions thereof.)

3. The toner according to claim 1, wherein the charge-controlling agent is a compound represented by a following formula (3): 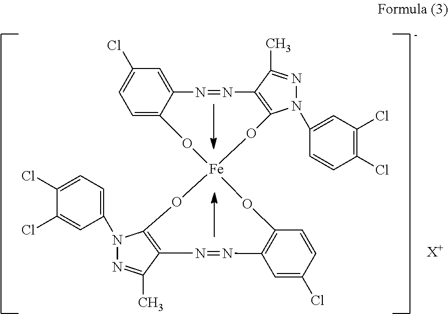
(wherein X⁺ represents hydrogen ion, alkali metal ion, ammonium ion, alkylammonium ion, or mixed ions thereof.)

4. The toner according to claim 1, wherein not less than 50% by mass and not more than 100% by mass of the polyester resin is contained based on the total amount of the resin in the toner.

5. The toner according to claim 1, wherein the polyester resin is a polyester resin obtained by condensation polymerization of one or more carboxylic acid components selected from the group consisting of terephthalic acid, fumaric acid, trimellitic acid, and trimellitic anhydride with one or more alcohol components selected from the group consisting of ethylene glycol, neopentyl glycol, 1,4-cyclohexanedimethanol, and 1,2-propanediol.

6. The toner according to claim 1, wherein the polyester resin is a polyester resin obtained by condensation polymerization of terephthalic acid, fumaric acid, ethylene glycol, and neopentyl glycol.

7. The toner according to claim 1, wherein the polyester resin is a polyester resin obtained by condensation polymerization of terephthalic acid, fumaric acid, trimellitic acid, ethylene glycol, and neopentyl glycol.

8. The toner according to claim 1, wherein the polyester resin is a polyester resin obtained by condensation polymerization of terephthalic acid, fumaric acid, trimellitic anhydride, ethylene glycol, and neopentyl glycol.
